(19) United States
(12) Patent Application Publication
(10) Pub. No.: US 2026/0164160 A1
(43) Pub. Date: Jun. 11, 2026

(54) Electronic Devices and Corresponding Methods for Replacing User Interface Control Mappings in Response to User Input

(71) Applicant: Motorola Mobility LLC, Chicago, IL (US)

(72) Inventors: Amit Kumar Agrawal, Bangalore (IN); Himanshu Chug, Bangalore (IN)

(21) Appl. No.: 18/977,683

(22) Filed: Dec. 11, 2024

(51) Int. Cl. H04R 1/10; G06F 3/04847; G06F 3/04883

(52) U.S. Cl. CPC H04R 1/1041; G06F 3/04847; G06F 3/04883

(57) ABSTRACT

An electronic device and corresponding methods involve detecting a predefined gesture at a user interface and replacing a default control mapping with another default control mapping of another electronic device in an asymmetrically control mapped electronic device pair. The predefined gesture can include various user inputs, such as a sliding gesture. The method further includes receiving user input after the replacing and controlling the electronic device based on the new control mapping. The method can include returning the default control mapping in response to predefined conditions, such as a timer expiration, repeated user input, or an override gesture. The system enhances the overall user experience in scenarios like mono mode operation of truly wireless stereo (TWS) earbuds.

### BACKGROUND

### Technical Field

This disclosure relates generally to electronic devices, and more particularly to electronic devices having user interfaces.

### Background Art

Portable electronic device usage has become ubiquitous. Vast majorities of the population carry a smartphone, tablet computer, or laptop computer daily to communicate with others, stay in formed, to consume entertainment, and to manage their lives. As the technology incorporated into these portable electronic devices has become more advanced, so too has their feature set. It would be advantageous to have an improved electronic device drawing new functionality from these new features.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory electronic device in accordance with one or more embodiments of the disclosure.

FIG. 2 illustrates one explanatory block diagram schematic for an electronic device in accordance with one or more embodiments of the disclosure.

FIG. 3 illustrates one explanatory electronic device operating in conjunction with a companion electronic device, along with one or more method steps, in accordance with one or more embodiments of the disclosure.

FIG. 4 illustrates another explanatory electronic device operating in conjunction with a companion electronic device, along with one or more method steps, in accordance with one or more embodiments of the disclosure.

FIG. 5 illustrates still another explanatory electronic device operating in conjunction with a companion electronic device, along with one or more method steps, in accordance with one or more embodiments of the disclosure.

FIG. 6 illustrates one explanatory method in accordance with one or more embodiments of the disclosure.

FIG. 7 illustrates another explanatory method in accordance with one or more embodiments of the disclosure.

FIG. 8 illustrates various embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to detecting, by one or more processors, a predefined gesture at a user interface or one electronic device of an asymmetrically control mapped electronic device pair and, in response to the predefined gesture, replacing a default control mapping of the electronic device with another default control mapping of another electronic device of the asymmetrically control mapped electronic device pair. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of, in response to determining that only one companion electronic device of an asymmetrically control mapped companion electronic device pair is actively being used and is receiving a control mapping switch gesture at a user interface, causing the only one companion electronic device to remap its user interface with a control mapping belonging to another companion electronic device of the asymmetrically control mapped companion electronic device pair as described herein. The non-processor circuits may include, but are not limited to, a radio receiver, a radio transmitter, signal drivers, clock circuits, power source circuits, and user input devices.

As such, these functions may be interpreted as steps of a method to perform determining, with a communication device paired with asymmetrically control mapped companion electronic device pair, that only one control mapped companion electronic device is actively being used by a user. The method then receives, by the communication device from the only one control mapped companion electronic device, signals indicating that a control mapping switch gesture was received by a user interface of the only one control mapped companion electronic device. In one or more embodiments, the method then comprises delivering, by the communication device, remapping control signals to the only one control mapped companion electronic device causing a control map at the user interface to switch from a first control mapping to a second control mapping.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Wearable technology encompasses electronic devices that can be worn on the body, often incorporating sensors and wireless communication capabilities. These devices include smartwatches, fitness trackers, and truly wireless stereo (TWS) earbuds. TWS earbuds, in particular, offer wireless audio playback and various control functionalities through touch or gesture-based inputs. Applications of wearable technology range from health monitoring and fitness tracking to hands-free communication and entertainment.

In the realm of TWS earbuds, users seek seamless and intuitive control over audio playback, call management, and other functionalities. These earbuds often feature touch-sensitive surfaces or sensors that allow users to perform actions such as play/pause, volume adjustment, and call handling through simple gestures. The goal is to provide a user-friendly experience that enhances convenience and accessibility, especially in scenarios where users may have limited ability to interact with their devices directly.

Achieving seamless control in TWS earbuds can present challenges, particularly when users operate in a single earbud mode, sometimes referred to as a “mono mode,” where only one earbud is in use. This mode can occur intentionally, for situational awareness, or unintentionally, due to battery depletion or malfunction of one earbud. Embodiments of the disclosure contemplate that when a pair of earbuds are configured as an asymmetrically control mapped electronic device pair, with control mappings of user interfaces of each earbud configured differently, users may lose access to certain controls that are exclusively mapped to the unused earbud when operating in the mono mode.

Embodiments of the disclosure contemplate that this can lead to a diminished user experience. Illustrating by example, users can face limitations in performing certain actions, such as answering calls or adjusting volume, which are mapped to the unavailable earbud.

Advantageously, embodiments of the disclosure provide a solution to this problem that allows users to retain full control functionality in mono mode. Advantageously, embodiments of the disclosure ensure that all essential operations can be performed regardless of which earbud is in use.

In one or more embodiments, a method in an electronic device of an asymmetrically control mapped electronic device pair involves detecting, by one or more processors of the electronic device, a predefined gesture at a user interface. Upon detecting the predefined gesture, in one or more embodiments the method includes replacing, by the one or more processors at the user interface, a default control mapping of the electronic device with another default control mapping of another electronic device of the asymmetrically control mapped electronic device pair.

The predefined gesture can include various types of user inputs, such as a sliding gesture. In one or more embodiments, the method further comprises receiving, by the user interface, user input after the replacing, and controlling, by the one or more processors, the electronic device as a function of where the user input is received at the another default control mapping. In one or more embodiments the method also includes returning, by the one or more processors at the user interface, the default control mapping in response to a predefined condition occurring. This predefined condition can include an expiration of a timer initiated when the predefined gesture is received, receiving the user input again at the user interface within a predefined duration threshold, or receiving a predefined override gesture at the user interface.

The predefined override gesture can include one of a long tap, a double tap, or a triple tap. The replacing occurs when the another electronic device of the asymmetrically control mapped electronic device pair is not in use or when an energy level of an energy storage device of the another electronic device of the asymmetrically control mapped electronic device pair is below a predefined threshold.

As noted above, embodiments of the disclosure contemplate that in the realm of TWS earbuds, users seek seamless and intuitive control over audio playback, call management, and other functionalities. These earbuds often feature touch-sensitive surfaces or sensors that allow users to perform actions such as play/pause, volume adjustment, and call handling through simple gestures. The goal is to provide a user-friendly experience that enhances convenience and accessibility, especially in scenarios where users may have limited ability to interact with their devices directly.

Achieving seamless control in TWS earbuds can present challenges, particularly when users operate in a single earbud mode, sometimes referred to as a “mono mode,” where one earbud is in use for the aforementioned reasons. Existing solutions often fail to address the limitations faced by users in mono mode. Users can face limitations in performing certain actions, such as answering calls or adjusting volume, which are mapped to the unavailable earbud. This can lead to a diminished user experience, as users may need to manually configure the functions each time based on which earbud is being used, which is not convenient.

Advantageously, embodiments of the disclosure provide a solution to this problem that allows users to retain full control functionality in mono mode. In one or more embodiments, an electronic device comprises a communication device and one or more processors operable with the communication device. In one or more embodiments, the one or more processors, in response to determining that only one companion electronic device of an asymmetrically control mapped companion electronic device pair is actively being used and is receiving a control mapping switch gesture at a user interface, cause the only one companion electronic device to remap the user interface with a control mapping belonging to another companion electronic device of the asymmetrically control mapped companion electronic device pair.

In one or more embodiments, the communication device facilitates the interaction between the processors and the companion electronic devices, ensuring seamless communication and control. The processors execute instructions to detect the active use of a single companion electronic device and recognize the control mapping switch gesture. Upon detection, the processors initiate the remapping process, transferring the control functionalities from the inactive companion electronic device to the active one. This remapping allows the user to access and utilize the control features of both companion electronic devices through the single active device, enhancing the overall user experience and maintaining functionality even in mono mode operation. This ensures that operations can be performed regardless of which earbud is in use.

In effect, embodiments of the disclosure dynamically remap control gestures to the active earbud, providing a consistent and uninterrupted user experience. Advantageously, by incorporating a communication device and one or more processors operable with the communication device, the electronic device can dynamically detect when only one companion electronic device of an asymmetrically control mapped companion electronic device pair is actively being used. This allows the system to adapt to the user's current usage scenario, ensuring that control functionalities are not lost when one earbud is inactive or not worn.

The processors, upon determining the active use of a single companion electronic device and receiving a control mapping switch gesture at the user interface, can remap the user interface of the active device with the control mapping of the inactive device. This remapping ensures that the user retains access to all necessary controls, thereby maintaining a seamless and uninterrupted user experience even in mono mode operation.

For example, if a user is wearing only the left earbud, which typically controls volume up, the system can remap the controls so that the left earbud can also perform functions originally mapped to the right earbud, such as volume down or answering calls. This flexibility enhances the usability of the earbuds, particularly in situations where the user may have limited ability to interact with both earbuds simultaneously.

Additionally, the communication device facilitates seamless interaction between the processors and the companion electronic devices, ensuring that the remapping process is executed efficiently and without noticeable delay. This capability is particularly beneficial in scenarios where quick response times are critical, such as during phone calls or while adjusting audio playback settings.

Embodiments of the disclosure can work in an electronic device that is in communication with an asymmetrically control mapped electronic device pair to control the asymmetrically control mapped electronic device pair. In other embodiments, the process steps described herein can be performed in the asymmetrically control mapped electronic device pair itself. When implemented in one or more ear buds, certain advantages occur. Illustrating by example, by detecting a predefined gesture at a user interface and replacing the default control mapping of an electronic device with another default control mapping of another electronic device in an asymmetrically control mapped electronic device pair, the system ensures that users can maintain full control functionality even when only one earbud is in use. This approach addresses the limitations faced in mono mode, where certain controls are typically unavailable, thereby enhancing the overall user experience.

In one or more embodiments, the method leverages the predefined gesture to dynamically remap control functionalities, allowing the active earbud to perform actions that would otherwise be exclusive to the inactive earbud. This remapping process ensures that essential operations, such as answering calls or adjusting volume, can be performed regardless of which earbud is being used, thus providing a seamless and uninterrupted user experience.

Implementing this method in TWS earbuds allows for greater flexibility and usability, particularly in scenarios where users may have limited ability to interact with both earbuds simultaneously. For example, if a user is wearing only the left earbud, the system can remap the controls so that the left earbud can also perform functions originally mapped to the right earbud. This capability is especially beneficial in situations where one earbud is not worn due to battery depletion or other reasons.

Furthermore, the method enhances the adaptability of the earbuds by ensuring that control functionalities are not lost when one earbud is inactive. This dynamic remapping of control gestures to the active earbud provides a consistent and uninterrupted user experience, improving the overall functionality and convenience of the TWS earbuds.

To see how embodiments of the disclosure can solve problems that occur in real life use case examples, consider a scenario where a user, Lisa, frequently uses her TWS earbuds during her daily jogs. Lisa enjoys listening to music and staying connected through hands-free calls.

One day, while jogging, the battery in one of her earbuds becomes depleted of energy, forcing her to switch to mono mode. As she continues her run, she receives a call from her friend, Mark. Lisa attempts to answer the call by tapping her earbud but quickly realizes that the gesture to answer calls is configured on the other earbud, which is now inactive due to the battery depletion. Frustrated, Lisa has to stop her run, take out her phone, and manually answer the call.

In another instance, imagine a user named John who is using his TWS earbuds while working from home. John often switches between listening to music and attending virtual meetings. One day, he decides to use only one earbud to stay aware of his surroundings.

During a meeting, John needs to adjust the volume, but the gesture for volume control is mapped to the other earbud, which he is not wearing. John finds himself unable to adjust the volume without manually changing the settings on his device, disrupting his workflow and causing inconvenience.

These real-life use cases highlight the challenges users face when operating TWS earbuds in mono mode. The inability to access certain controls mapped to the inactive earbud can lead to a diminished user experience.

Embodiments of the disclosure address these challenges by dynamically remapping control gestures to the active earbud, ensuring that users retain full control functionality regardless of which earbud is in use. This approach enhances the overall usability and convenience of TWS earbuds, providing a seamless and uninterrupted user experience even in mono mode operation.

In one or more embodiments, a method comprises determining, with a communication device paired with an asymmetrically control mapped companion electronic device pair, that only one control mapped companion electronic device is actively being used by a user. In one or more embodiments, the communication device receives signals from the only one control mapped companion electronic device, indicating that a control mapping switch gesture was received by a user interface of the only one control mapped companion electronic device. In one or more embodiments, the communication device then delivers remapping control signals to the only one control mapped companion electronic device, causing a control map at the user interface to switch from a first control mapping to a second control mapping.

In one or more embodiments, the first control mapping is a default control mapping for the only one control mapped companion electronic device pair, and the second control mapping is another default control mapping of another control mapped companion electronic device of the asymmetrically control mapped companion electronic device pair. In one or more embodiments, the first control mapping and the second control mapping are different, ensuring that the user retains access to all necessary controls regardless of which earbud is in use. Advantageously, this method enhances the usability and convenience of the electronic device, particularly in scenarios where the user may have limited ability to interact with both earbuds simultaneously.

Advantageously, by determining that only one control mapped companion electronic device is actively being used, the system can dynamically adapt to the user's current usage scenario, ensuring that control functionalities are not lost when one earbud is inactive or not worn. This enhances the overall user experience by maintaining seamless control over the device's functionalities.

Receiving signals from the only one control mapped companion electronic device indicating that a control mapping switch gesture was received allows the system to accurately detect user intent and respond accordingly. This ensures that the user can continue to perform essential operations, such as answering calls or adjusting volume, even when only one earbud is in use.

Delivering remapping control signals to the only one control mapped companion electronic device to switch the control map at the user interface from a first control mapping to a second control mapping ensures that the user retains access to all necessary controls. This dynamic remapping process provides a consistent and uninterrupted user experience, particularly in scenarios where the user may have limited ability to interact with both earbuds simultaneously.

For example, if a user is wearing only the left earbud, the system can remap the controls so that the left earbud can also perform functions originally mapped to the right earbud. This flexibility enhances the usability of the earbuds, especially in situations where one earbud is not worn due to battery depletion or other reasons, thereby improving the overall functionality and convenience of the TWS earbuds. Still other advantages offered by embodiments of the disclosure will be described below. Still others will be obvious to those of ordinary skill in the art having the benefit of this disclosure.

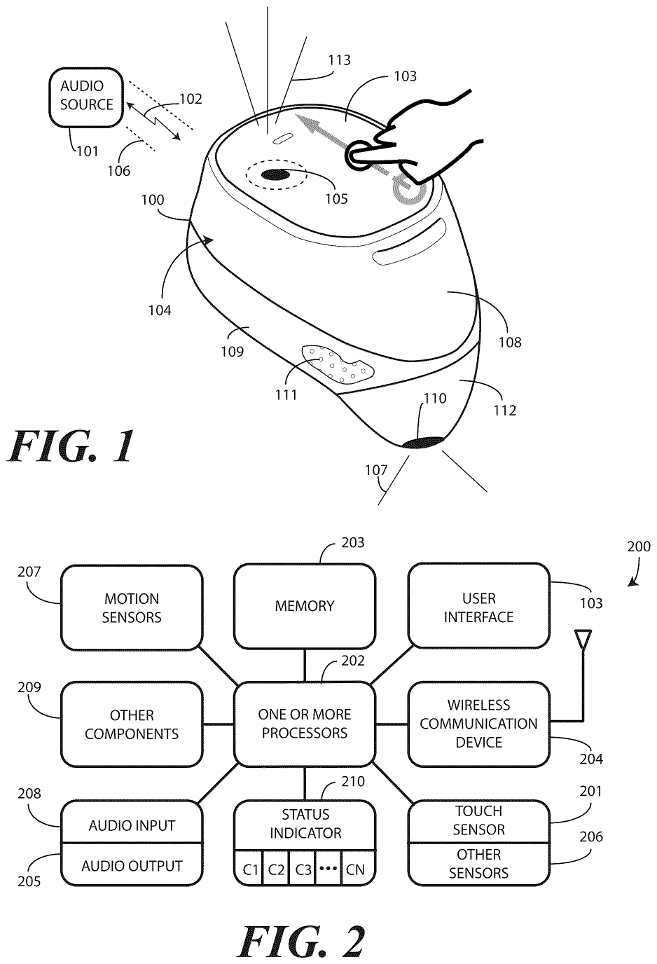

Turning now to FIG. 1, illustrated therein is one explanatory system in accordance with one or more embodiments of the disclosure. The system includes an audio source 101 and an electronic device 100, which is configured as one wireless ear bud of an asymmetrically control mapped electronic device pair in this illustrative example.

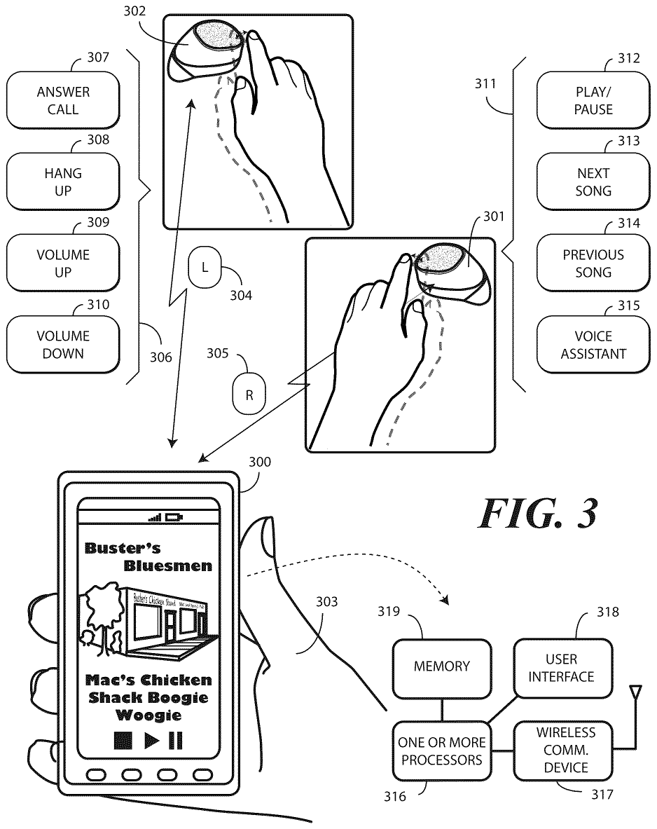

While one ear bud of the asymmetrically control mapped electronic device pair is shown, it should be noted that where the electronic device 100 is configured as an ear bud, it will frequently be sold and/or used as a pair. Accordingly, in one or more embodiments the electronic device 100 comprises a first ear bud and a second ear bud. Since the ear bud pair is asymmetrically control mapped, in one or more embodiments the control map defining user controls on one ear bud is different that the control map defining the user controls on the earbud, as will be illustrated below in FIG. 3.

However, only one electronic device 100 is shown in FIG. 1 for simplicity. While the electronic device 100 of FIG. 1 is configured as an ear bud, embodiments of the disclosure are applicable to any number of other communication devices that are operable with an audio source 101.

The audio source 101 can take any number of forms. Illustrating by example, in one explanatory embodiment used for illustrative purposes in FIGS. 3-5 below the audio source 101 comprises a companion electronic device configured as a smartphone that is in communication with the electronic device 100 via a local area, peer-to-peer network. However, it should be obvious to those of ordinary skill in the art having the benefit of this disclosure that other audio sources may be substituted for the explanatory smartphone of FIGS. 3-5.

For example, the audio source 101 could equally be a conventional desktop computer, palm-top computer, a tablet computer, a gaming device, a media player, or other device. In still other embodiments, the audio source 101 comprises a remote server or cloud server delivering electronic audio signals 102 to the electronic device 100 across a network. Accordingly, numerous other applications for embodiments of the disclosure will be obvious to those of ordinary skill in the art having the benefit of this disclosure.

In one or more embodiments, the electronic device 100 includes a touch-sensitive surface 103 that employs a control mapping along that touch-sensitive surface 103 to define one or more user interface actuators that allow a user to control the operation of the electronic device 100. In one embodiment the touch-sensitive surface 103 is configured as capacitive touch surfaces along a device housing 104 of the electronic device 100. However, in other embodiments a control mapping can be applied to a plurality of push buttons, slider switches, touch pads, rocker switches, or other devices.

In one or more embodiments, the touch-sensitive surface 103 may be able to use the control mapping to define one or more user actuation targets presented as virtual keys on a touch sensitive display. Still others can comprise voice commands delivered to a voice control interface. Even more others will be obvious to those of ordinary skill in the art having the benefit of this disclosure.

In one or more embodiments, the electronic device 100 is configured to establish a wireless communication channel 106 with an audio source 101. In one embodiment, where the audio source 101 comprises a locally paired device such as a smartphone, the wireless communication channel 106 comprise local area, ad-hoc, peer-to-peer communications using a protocol such as Bluetooth™. Where the audio source 101 comprises a remote device, such as a cloud server in communication with the electronic device 100 across a network, other wide area protocols such as the transport protocol (TCP), the user datagram protocol (UDP), or another protocol can be used.

In this illustrative embodiment, the electronic device 100 receives electronic audio signals 102 from the audio source 101. The electronic audio signals 102 can be various types of audio signals. Illustrating by example, in one embodiment the electronic audio signals 102 comprise telephone call audio signals that are exchanged when the electronic device 100 is being used to communicate in a telephone call.

In another embodiment, the electronic audio signals 102 comprise music audio signals, music playback audio signals, or music player audio signals that are exchanged when the electronic device 100 is being used to deliver acoustic audio signals 107 in the form of music to a user such as an MP3 recording of a song. Other examples of predefined types of audio signals received as electronic audio signals 102 from the audio source 101 will be obvious to those of ordinary skill in the art having the benefit of this disclosure.

It should be noted that stereo music content is only one example of multi-content information that can be delivered in accordance with one or more embodiments of the disclosure, as information other than channel content may be transmitted as well. Data content may be interlaced with other content, such as audio or video. For example, the content may include left channel audio, right channel audio, and data like call initiation, transfer, or drop requests. Other content or information suitable for use with embodiments of the disclosure will be obvious to those of ordinary skill in the art having the benefit of this disclosure.

In one or more embodiments, when the electronic audio signals 102 are received, they are delivered to a transducer such as a local loudspeaker or other audio output device. In one or more embodiments, one or more processors of the electronic device 100 are then operable to determine, from the electronic audio signals 102, an audio type of the electronic audio signals 102. For example, the one or more processors of the electronic device 100 may analyze the electronic audio signals 102, audio source information, including connection information for the audio source 101, and so forth to determine, for instance, whether the electronic audio signals 102 are telephone call audio signals, music audio signals, or another type of audio signals, e.g., white noise audio signals.

In one or more embodiments, the electronic device 100 is capable of placement in either the right or left ear. Where the electronic audio signals 102 comprise multi-channel audio, e.g., a left channel and a right channel, the electronic device 100 can be configured with an orientation device so as to determine which ear it is in and, accordingly, which channel to be play. Where included, the orientation device can determine a physical orientation so as to play the proper channel.

For example, if the electronic device 100 is one of an asymmetrically control mapped electronic device pair and is placed in the left ear, one or more control circuits of the electronic device 100 can select the left channel from the multi-channel audio information for delivery to its loudspeaker, and vice versa. One example of a suitable orientation device is an accelerometer, which can determine in which direction gravity is acting, and therefore in which ear each device is disposed. Where no orientation device is included, determining which wireless communication device plays the left channel or right channel can be user configurable. For example, a user may press a button, actuate a user interface actuator, deliver a voice command, and so forth.

The illustrative electronic device 100 of FIG. 1 includes an upper device housing 108 attached to a lower device housing 109. A circuit assembly is disposed within the electronic device 100, as well as a rechargeable battery, an acoustic driver, and other components.

In one or more embodiments, either the upper device housing 108 or the lower device housing 109 can define a microphone port to direct acoustic energy to one or more microphones of the circuit assembly. For example, such microphone ports can be disposed along the housing members to define acoustic beams along which acoustic energy is received. When the electronic device 100 is positioned in a user's ear, an acoustic beam can be directed toward the user's mouth so that the electronic device 100 can be used as a two-way communication device.

In the illustrative embodiment of FIG. 1, the lower device housing 109 defines an acoustic driver port 110. An acoustic driver can be positioned within the acoustic driver port 110. When the electronic device 100 is positioned within the user's ear, the acoustic driver can deliver acoustic audio signals 107 in the form of acoustic energy through the acoustic driver port 110 to the user's eardrum.

In one or more embodiments, the housing members are surrounded, or at least partially surrounded, by a soft, outer rubber layer 111. The soft, outer rubber layer 111, while optional, aids in user comfort by providing a soft surface against the contours of the user's ear. A cushion element 112 can be attached to the lower device housing 109 to provide an acoustic seal between a user's ear canal and the lower device housing 109. The cushion element 112 can be manufactured in varying sizes so that the electronic device 100 can be used in different sized ears.

In this illustrative embodiment, the upper surface of the electronic device 100 defines a touch-sensitive surface 103 disposed along the upper device housing 108 that can define a user interface actuator in accordance with a control mapping that defines the function and arrangement of the user interface actuators. As used herein, a “user interface actuator” is a user interface element that can be actuated by a user to cause one or more control circuits of the electronic device 100 to perform an action. As will be explained below with reference to FIG. 3, examples of such actions include answering incoming calls, hanging up on ongoing calls, turning the volume of the acoustic driver situated within the acoustic driver port 110 up, turning the volume of the acoustic driver situated within the acoustic driver port 110 down, play the next song, pause the current song, skip to the previous song, actuate a voice assistant control function, or perform other functions. Of course, this list of functions is illustrative only, as numerous other will be obvious to those of ordinary skill in the art having the benefit of this disclosure.

In the illustrative embodiment of FIG. 1, the touch-sensitive surface 103 is defined by a capacitive touchpad formed by a flexible circuit substrate being placed beneath the upper surface of the upper device housing 108. The flexible circuit substrate includes a plurality of electrical conductors that define one or more electric field lines. It also includes a one or more light sources 105 that can project light through the upper surface of the upper device housing 108 to deliver a status indicator output or define user actuation targets, as will be explained in more detail below. In one or more embodiments, when a user places a finger along the upper surface of the upper device housing 109, these electrical field lines change, thereby actuating the user actuation targets defined by the touch-sensitive surface 103.

It should be noted that while the electronic device 100 is shown illustratively as an ear bud in FIG. 1, in other embodiments the electronic device 100 can be configured as other types of devices configured to deliver acoustic audio signals 107 to a user. Illustrating by example, in another embodiment the electronic device 100 is configured as a pair of headphones. In another embodiment, the electronic device 100 is configured as an earpiece. Still other devices will be obvious to those of ordinary skill in the art having the benefit of this disclosure.

Turning now to FIG. 2, illustrated therein is one explanatory block diagram schematic 200 of the explanatory electronic device (100) of FIG. 1. It should be understood that the block diagram schematic 200 of FIG. 2 is provided for illustrative purposes only and for illustrating components of one electronic device 100 in accordance with embodiments of the disclosure and is not intended to be a complete block diagram schematic 200 of the various components that can be included with the electronic device (100). Therefore, other electronic devices in accordance with embodiments of the disclosure may include various other components not shown in FIG. 2 or may include a combination of two or more components or a division of a particular component into two or more separate components, and still be within the scope of the present disclosure.

In one or more embodiments, the block diagram schematic 200 is configured as a printed circuit board assembly disposed within a device housing (104) of the electronic device 100. Various components can be electrically coupled together by conductors or a bus disposed along one or more printed circuit boards.

The illustrative block diagram schematic 200 of FIG. 2 includes many different components. Embodiments of the disclosure contemplate that the number and arrangement of such components can change depending on the particular application. Accordingly, electronic devices configured in accordance with embodiments of the disclosure can include some components that are not shown in FIG. 2, and other components that are shown may not be needed and can therefore be omitted.

As noted above with reference to FIG. 1, in one or more embodiments the electronic device (100) includes a touch-sensitive surface 103 defining a user interface. In the embodiment of FIG. 1, the user interface is configured as a touch-sensitive surface 103 through which a light source (105) could project light of different colors. However, in other embodiments the user interface could be configured in other ways as well.

Illustrating by example, in one or more embodiments the user interface is configured as a display positioned on the upper surface of the upper device housing (108). In one or more embodiments, the display comprises a touch sensitive display. Where so configured, information, graphical objects, user actuation targets, and other graphical indicia can be presented using the display. Regardless of whether the user interface is configured as a display or touch sensitive surface, in one or more embodiments, so as to be touch sensitive, the user interface comprises a touch-sensitive surface 103.

In one or more embodiments, the touch-sensitive surface 103 can comprise a touch sensor 201 that can be any of a capacitive touch sensor, an infrared touch sensor, resistive touch sensors, inductive touch sensing, another touch-sensitive technology, or combinations thereof. Capacitive touch-sensitive devices include a plurality of capacitive sensors, e.g., electrodes, which are disposed along a substrate. Where so configured, each capacitive sensor can be configured, in conjunction with associated control circuitry, e.g., the one or more processors 202, to detect an object in close proximity with—or touching—the surface of the display(s) by establishing electric field lines between pairs of capacitive sensors and then detecting perturbations of those field lines.

The electric field lines can be established in accordance with a periodic waveform, such as a square wave, sine wave, triangle wave, or other periodic waveform that is emitted by one sensor and detected by another. The capacitive sensors can be formed, for example, by disposing indium tin oxide patterned as electrodes on the substrate. Indium tin oxide is useful for such systems because it is transparent and conductive. Other technologies include metal mesh, silver nano wire, graphene, and carbon nanotubes. Further, it is capable of being deposited in thin layers by way of a printing process. The capacitive sensors may also be deposited on the substrate by electron beam evaporation, physical vapor deposition, or other various sputter deposition techniques.

In one or more embodiments, users can deliver user input to the user interface, be it a display or touch sensitive surface, by delivering touch input from a finger, stylus, or other objects disposed proximately with the user interface. Where the user interface is configured as a display, in one or more embodiments it is configured as an active matrix organic light emitting diode (AMOLED) display. However, it should be noted that other types of displays, including liquid crystal displays, are suitable for use with the user interface and would be obvious to those of ordinary skill in the art having the benefit of this disclosure.

In one embodiment, the electronic device (100) includes one or more processors 202. In one embodiment, the one or more processors 202 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device.

The application processor and the auxiliary processor(s) can be operable with the various components of the block diagram schematic 200. Each of the application processor and the auxiliary processor(s) can be configured to process and execute executable software code to perform the various functions of the electronic device (100) with which the block diagram schematic 200 operates. A storage device, such as memory 203, can optionally store the executable software code used by the one or more processors 202 during operation.

In this illustrative embodiment, the block diagram schematic 200 also includes a communication device 204 that can be configured for wired or wireless communication with one or more other devices or networks. The networks can include a wide area network, a local area network, and/or personal area network. The communication device 204 may also utilize wireless technology for communication, such as, but are not limited to, peer-to-peer or ad hoc communications such as HomeRF, Bluetooth and IEEE 802.11 and other forms of wireless communication such as infrared technology. The communication device 204 can include wireless communication circuitry, one of a receiver, a transmitter, or transceiver, and one or more antennas.

In one embodiment, the one or more processors 202 can be responsible for performing the primary functions of the electronic device with which the block diagram schematic 200 is operational. For example, in one embodiment the one or more processors 202 comprise one or more circuits operable with the user interface to present presentation information to a user. Additionally, the one or more processors 202 can be operable with an audio output 205 to deliver audio output to a user. The executable software code used by the one or more processors 202 can be configured as one or more modules that are operable with the one or more processors 202. Such modules can store instructions, control algorithms, and so forth.

Various sensors 206 can be operable with the one or more processors 202. In one or more embodiments, the other sensors 206 include one or more proximity sensors can be configured to detect objects proximately located with the user interface actuator or device housing (104) of the electronic device (100). The proximity sensors can fall into one of two camps: active proximity sensors that include a transmitter and receiver pair, and “passive” proximity sensors that include a receiver only. Either the proximity detector components or the proximity sensor components can be generally used for gesture control and other user interface protocols in one or more embodiments. Either the proximity detector components or the proximity sensor components can be generally used for distance determination, such as measuring distances between objects situated within the environment of the electronic device and/or determining changes in distance between the electronic device (100) and objects situated within the environment.

As used herein, a “proximity sensor component” comprises a signal receiver only that does not include a corresponding transmitter to emit signals for reflection off an object to the signal receiver. A signal receiver only can be used due to the fact that an external source, such as the body of a person or other heat-generating object external to the electronic device 100, can serve as the transmitter. Illustrating by example, in one embodiment the proximity sensor components comprise only a signal receiver to receive signals from objects external to the device housing (104) of the electronic device (100). In one embodiment, the signal receiver is an infrared signal receiver to receive an infrared emission from a source, such as a human being, when the human being is approaching or near the electronic device (100).

Proximity sensor components are sometimes referred to as “passive IR detectors” due to the fact that a person or other warm object serves as the active transmitter. Accordingly, the proximity sensor component requires no transmitter since objects disposed external to the housing deliver emissions that are received by the infrared receiver. As no transmitter is required, each proximity sensor component can operate at a very low power level.

In one embodiment, the signal receiver of each proximity sensor component can operate at various sensitivity levels so as to cause the at least one proximity sensor component to be operable to receive the infrared emissions from different distances. For example, the one or more processors 202 can cause each proximity sensor component to operate at a first “effective” sensitivity so as to receive infrared emissions from a first distance. Similarly, the one or more processors 202 can cause each proximity sensor component to operate at a second sensitivity, which is less than the first sensitivity, so as to receive infrared emissions from a second distance, which is less than the first distance. The sensitivity change can be effected by causing the one or more processors 202 to interpret readings from the proximity sensor component differently.

By contrast, “proximity detector components” include a signal emitter and a corresponding signal receiver, which constitute an “active” pair. While each proximity detector component can be any one of various types of proximity sensors, such as but not limited to, capacitive, magnetic, inductive, optical/photoelectric, imager, laser, acoustic/sonic, radar-based, Doppler-based, thermal, and radiation-based proximity sensors, in one or more embodiments the proximity detector components comprise infrared transmitters and receivers that define an active IR pair.

In one or more embodiments, each proximity detector component can be an infrared proximity sensor set that uses a signal emitter that transmits a beam of infrared light that reflects from a nearby object and is received by a corresponding signal receiver. Proximity detector components can be used, for example, to compute the distance to any nearby object from characteristics associated with the reflected signals. The reflected signals are detected by the corresponding signal receiver, which may be an infrared photodiode used to detect reflected light emitting diode (LED) light, respond to modulated infrared signals, and/or perform triangulation of received infrared signals.

In one or more embodiments the other sensors 206 include a skin sensor is configured to determine when the electronic device (100) is touching the skin of a person. For example, in one or more embodiments the skin sensor can determine when the electronic device (100) is placed within the ear of a user. In one embodiment, the skin sensor can include a substrate with an electrode disposed thereon. The electrode can confirm the object touching the skin sensor is skin by detecting electrical signals generated by a heartbeat in one embodiment. Other forms of skin sensors will be obvious to those of ordinary skill in the art having the benefit of this disclosure.

The other sensors 206 can include a light sensor. The light sensor can be used to detect whether or not direct light is incident on the device housing (104) of the electronic device 100 in one or more embodiments. The light sensor can also be used to detect an intensity of ambient light is above or below a predefined threshold in one or more embodiments. In one or more embodiments the light sensor can detect changes in optical intensity, color, light, or shadow in the near vicinity of the electronic device (100). The other sensors 206 can also include an audio input 208 in the form of one or more microphones that are operable to receive acoustic input. The other sensors 206 can also include a moisture sensor.

The electronic device 100 can include one or more motion sensors 207. The one or more motion sensors 207 can function as an orientation detector configured to determine a spatial orientation of the electronic device (100) in three-dimensional space. The one or more motion sensors 207 can include one or more accelerometers or gyroscopes. For example, an accelerometer may be embedded in the electronic circuitry of the electronic device (100) to show vertical orientation, constant tilt and/or whether the electronic device (100) is stationary. The measurement of tilt relative to gravity is referred to as “static acceleration,” while the measurement of motion and/or vibration is referred to as “dynamic acceleration.” A gyroscope can be used in a similar fashion.

In one or more embodiments, the one or more motion sensors 207 can detect motion of the electronic device (100). The one or more motion sensors 207 can be used to sense some of the gestures of a user as well. The one or more motion sensors 207 can be used to determine the spatial orientation of the electronic device (100) as well in three-dimensional space by detecting a gravitational direction. The one or more motion sensors 207 can also include an electronic compass to detect the spatial orientation of the electronic device (100) relative to the earth's magnetic field.

Other components 209 operable with the one or more processors 202 can include output components such as video, audio, and/or mechanical outputs. For example, the output components may include a video output component or auxiliary devices including a cathode ray tube, liquid crystal display, plasma display, incandescent light, fluorescent light, front or rear projection display, and light emitting diode indicator. Other examples of output components include audio output components such as the one or more loudspeakers or other alarms and/or buzzers. The other components 209 can also include a mechanical output component such as vibrating or motion-based mechanisms.

In one or more embodiments, a status indicator 210 that is operable with the one or more processors 202. The status indicator 210 is operable to present a status identifier that is visible, audible, or both, to third parties.

Turning back to FIG. 1, in this illustrative embodiment the touch-sensitive surface 103 and light source 105 work in tandem to provide status indicator output 113 through the surface of the user interface actuator. In one or more embodiments, the status indicator output 113 presents one of multiple colors along the surface of the touch-sensitive surface 103. In one or more embodiments, the colors comprise green, yellow, and red. These three colors are illustrative only, as other colors will be obvious to those of ordinary skill in the art having the benefit of this disclosure. Moreover, while three colors are used herein as an explanatory color set, in other embodiments the status indicator (210) will employ fewer than three colors. In still other embodiments, the status indicator (210) will employ more than three colors.

In another embodiment an electronic device can include one or more indicator bands configured as a status indicator (210) for presenting the status of an authorized user of the electronic device to third parties. Such indicator bands can be positioned at various locations around the device housing. The indicator bands can comprise a semi-rigid polymer light pipe positioned above one or more light sources. The semi-rigid polymer light pipe can be manufactured from silicone, for example.

The semi-rigid polymer light pipe can comprise a continuous band disposed along the device housing. Alternatively, the semi-rigid polymer light pipe can be manufactured as one or more linear or non-linear strips, one or more interlaced linear or non-linear strips, a matrix of linear or non-linear strips, or in other configurations.

The semi-rigid polymer light pipe can contours matching those of the electronic device. At least a portion of the semi-rigid polymer light pipe can extend distally beyond the surface of the device housing so as to more readily be seen. This results in a distal edge of the semi-rigid polymer light pipe being raised above the surface of the device housing.

In another embodiment an electronic device can includes one or more displays positioned along the device housing. In one or more embodiments, these one or more displays allow for the projection of color, text, or other visual indicia from the sides of the electronic device so that those colors, text, or visual indicia can be seen by third parties. Other examples of configurations of status indicators will be obvious to those of ordinary skill in the art having the benefit of this disclosure.

Now that various hardware components have been described, attention will be turned to methods of using electronic devices in accordance with one or more embodiments of the disclosure. Turning now to FIGS. 3-7, illustrated therein are various methods in an electronic device of an asymmetrically control mapped electronic device pair. The method involves detecting, by one or more processors of the electronic device, a predefined gesture at a user interface. Upon detecting the predefined gesture, the method includes replacing, by the one or more processors at the user interface, a default control mapping of the electronic device with another default control mapping of another electronic device of the asymmetrically control mapped electronic device pair.

The predefined gesture can include various types of user inputs, such as a sliding gesture. The method further comprises receiving, by the user interface, user input after the replacing, and controlling, by the one or more processors, the electronic device as a function of where the user input is received at the another default control mapping. The method also includes returning, by the one or more processors at the user interface, the default control mapping in response to a predefined condition occurring. This predefined condition can include an expiration of a timer initiated when the predefined gesture is received, receiving the user input again at the user interface within a predefined duration threshold, or receiving a predefined override gesture at the user interface.

The predefined override gesture can include one of a long tap, a double tap, or a triple tap. The replacing occurs when the another electronic device of the asymmetrically control mapped electronic device pair is not in use or when an energy level of an energy storage device of the another electronic device of the asymmetrically control mapped electronic device pair is below a predefined threshold.

Beginning with FIG. 3, illustrated therein is one explanatory electronic device 300 operating in conjunction with a pair of companion electronic devices, along with one or more method steps, in accordance with one or more embodiments of the disclosure. In this illustrative embodiment, the pair of companion electronic devices comprise an asymmetrically control mapped electronic device pair comprising a first companion electronic device 301 and a second companion electronic device 302.

In the illustrative embodiment of FIG. 3, the first companion electronic device 301 and the second companion electronic device 302 of the asymmetrically control mapped electronic device pair are configured as earbuds. These earbuds operate in conjunction with electronic device 300, which serves as a source device, to provide audio playback and control functionalities through touch or gesture-based inputs. Each earbud features a control mapping 306,311, allowing users to perform specific actions such as answering calls, adjusting volume, and managing playback through predefined gestures.

In this illustrative embodiment, the first companion electronic device 301 is configured as a right earbud, while the second companion electronic device 302 is configured as a left earbud. The user interface of each companion electronic device 301,302 defines a control mapping 306,311 defining a set of default controls that a user can interact with by delivering user input to the user interface.

Illustrating by example, in this embodiment the control mapping 306 for the left earbud allows a user 303 to perform operations such as answering a call 307, ending a call 308, turning the volume up 309, and turning the volume down 310. By contrast, the control mapping 311 of the right earbud allows the user 303 to perform operations such as playing and pausing music 312, skipping to the next song in a queue 313, skipping to the previous song in a queue 314, or actuating a voice assistant. These control mappings 306,311 and control operations are illustrative only, as others will be obvious to those of ordinary skill in the art having the benefit of this disclosure.

What is important to note is that the first companion electronic device 301 and the second companion electronic device 302 define an asymmetrically control mapped electronic device pair because the control operations that can be performed with one control mapping 306 are different than others than can be performed with the other control mapping 311. Indeed, the illustrative control mappings 306,311 of FIG. 3 are mutually exclusive in that no control operations from one are found in the other. In other embodiments, the control mappings 306,311 will partially overlap, with some control operations being found in each. However, to be an asymmetrically control mapped electronic device pair, the control mappings 306,311 must be different by at least one control feature. In one or more embodiments, this asymmetrical control mapping ensures that each earbud has distinct control functions, enhancing the overall user experience by providing intuitive and efficient control mechanisms.

While the embodiment in FIG. 3 depicts the companion electronic devices of the asymmetrically control mapped electronic device pair as earbuds, the concept of asymmetrically control mapped electronic device pairs can extend to various other types of electronic devices as well. For instance, the devices could be configured as smartwatches, where one watch controls fitness tracking functions while the other manages notifications and communication. Similarly, the devices could be implemented as fitness trackers, with one tracker monitoring heart rate and the other tracking steps and distance. Another potential configuration includes gaming controllers, where one controller handles movement and navigation while the other manages action buttons and triggers. Still another would be a pair of headphones, with each “can” of the headphones having a different control mapping.

Additional examples of asymmetrically control mapped electronic device pairs include smart glasses, where one lens displays augmented reality information and the other provides navigation assistance. The devices could also be configured as remote controls for home automation systems, with one remote managing lighting and the other controlling temperature and security settings. These configurations demonstrate the versatility of the asymmetrically control mapped electronic device pair concept, allowing for a wide range of applications across different types of electronic devices, each benefiting from the control mappings tailored to their specific functionalities. Other examples will be obvious to those of ordinary skill in the art having the benefit of this disclosure.

In this illustrative embodiment, the first companion electronic device 301 and the second companion electronic device 302 are truly wireless stereo (TWS) earbuds. TWS earbuds are a type of wireless earphones that do not have any physical wires connecting the left and right earpieces. Instead, a source device, one example of which is electronic device 300, transmits a wireless left channel 304 to the left earbud defined by second companion electronic device 302 and a wireless right channel 305 to the right earbud defined by first companion electronic device 301. Functioning in this manner, the asymmetrically control mapped electronic device pair of earbuds offer a completely wireless audio experience, allowing users to enjoy music, make phone calls, and interact with their devices without the need for cables.

TWS earbuds typically connect to a device, such as the smartphone defined by electronic device 300, a tablet, or a computer, via a near-field communication protocol such as Bluetooth™. In one or more embodiments, each earbud contains a battery, speaker, microphone, and control sensors, enabling independent operation. This means the user 303 can use both earbuds together for a stereo sound experience or use just one earbud in a “mono mode” for situational awareness or when the other earbud is not available.

These earbuds often feature touch-sensitive surfaces or sensors that allow users to control various functions through simple gestures. Common gestures include tapping, double-tapping, or holding the earbud to perform actions such as play/pause music, adjust volume, answer or end calls, and activate voice assistants.

TWS earbuds are popular for their convenience, portability, and ease of use. They are widely used for listening to music, making hands-free calls, and accessing voice assistants like Siri™ or Google™ Assistant. The absence of wires makes them ideal for activities such as exercising, commuting, and multitasking, providing users with a seamless and enjoyable audio experience.

In one or more embodiments, the electronic device 300 includes a communication device 317 and one or more processors 316 operable with the communication device 317. In one or more embodiments, the communication device 317 facilitates interaction between the one or more processors 316 and the companion electronic devices 301,302 defining the asymmetrically control mapped electronic device pair, thereby ensuring seamless communication and control. The communication device 317 may utilize wireless technology for communication, such as peer-to-peer or ad hoc communications like Bluetooth, IEEE 802.11, or other forms of wireless communication. The communication device 317 includes wireless communication circuitry, one of a receiver, a transmitter, or transceiver, and one or more antennas.

The one or more processors 316 are responsible for performing the primary functions of the electronic device 300. The one or more processors 316 can include an application processor and, optionally, one or more auxiliary processors. The application processor and the auxiliary processor(s) can be a microprocessor, a group of processing components, one or more ASICs, programmable logic, or other types of processing devices. The one or more processors 316 can execute instructions to detect the active use of a single companion electronic device and recognize a control mapping switch gesture. Upon detection, the one or more processors 316 can initiate a remapping process, transferring the control functionalities from an inactive companion electronic device to an active one. When two earbuds are in use, and the user 303 simply wants to reverse the control mappings 306,311, the same operation can occur in response to a switch gesture.

In one or more embodiments, the one or more processors 316 determine that only one companion electronic device of the asymmetrically control mapped companion electronic device pair is actively being used when the communication device receives proximity sensor signals indicating an in-ear condition only from one earbud. In one or more embodiments, the proximity sensors can detect objects proximately located with the user interface actuator or device housing of the electronic device 300. The proximity sensors can be active proximity sensors that include a transmitter and receiver pair, or passive proximity sensors that include a receiver only. The proximity sensors can be used for gesture control and other user interface protocols, as well as for distance determination.

In one or more embodiments, the one or more processors 316 also determine that only one companion electronic device of the asymmetrically control mapped companion electronic device pair is actively being used when the communication device receives motion data signals only from one earbud. The motion sensors can function as an orientation detector configured to determine the spatial orientation of the companion electronic devices 301,302 in three-dimensional space. The motion sensors can include one or more accelerometers or gyroscopes, which can detect motion, sense gestures, and determine the spatial orientation of the companion electronic devices 301,302 relative to the earth's magnetic field.

The one or more processors 316 can also be operable to determine that the only one companion electronic device of the asymmetrically control mapped companion electronic device pair is actively being used when one of the companion electronic devices 301,302 is operating in a monoaural mode of operation. In this mode, the communication device 317 is in communication only with the single active earbud. If, for example, the first companion electronic device 301 is the only earbud in use, remapping the default control mapping 311 to another control mapping 306 in response to a switch gesture ensures that control functionalities are not lost when one earbud is inactive or not worn. This dynamic remapping of control gestures to the active earbud provides a consistent and uninterrupted user experience, improving the overall functionality and convenience of the TWS earbuds.

In one or more embodiments, the memory 319 of the electronic device 300 stores executable software code and data necessary for the operation of the device. The memory 319 works in conjunction with the one or more processors 316 to execute instructions that control the various functionalities of the electronic device 300. This includes, in some embodiments, causing control mappings 306,311 of the companion electronic devices 301,302 to switch in response to detecting a predefined gesture at a user input. In one or more embodiments, the memory 319 also retains user preferences, system settings, and other relevant data that enable the electronic device 300 to operate efficiently and respond to user commands accurately.

The user interface 318 of the electronic device 300 provides an interface for the user 303 to interact with the electronic device 300 through touch or gesture-based inputs. The user interface 318 can include a touch-sensitive surface that detects user gestures such as taps, swipes, and holds. The user interface 318 ensures that users can easily and intuitively control the device's functionalities, enhancing the overall user experience by providing seamless and responsive interaction.

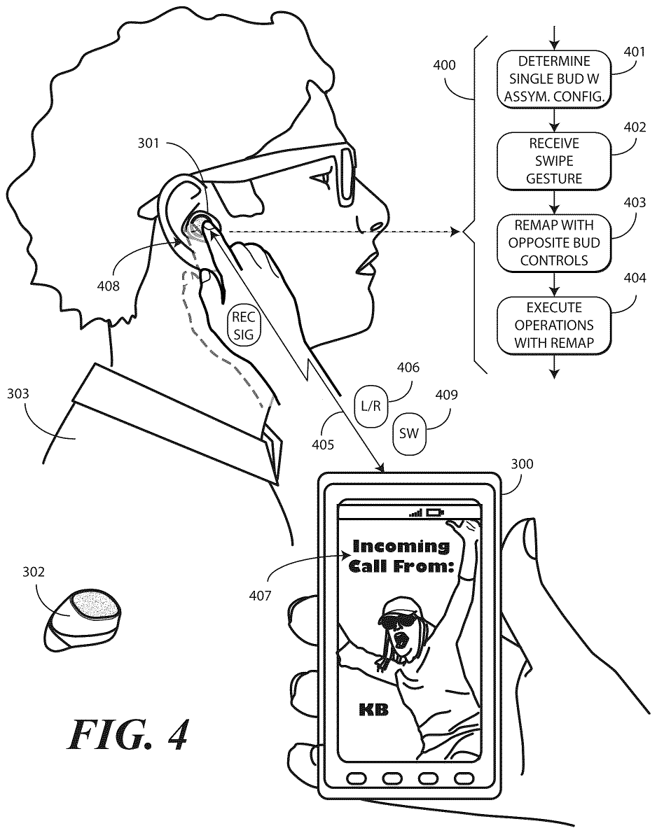

Turning now to FIG. 4, illustrated therein are one or more method steps for using the electronic device 300 and the asymmetrically control mapped electronic device pair defined by the first companion electronic device 301 and the second companion electronic device 302. In the illustrative embodiment of FIG. 4, the user 303 is only using the first companion electronic device 301 in the right ear. The second companion electronic device 302 is not in use.

In prior art devices, when the second companion electronic device is not in use, the controls associated with the control mapping of the second companion electronic device become unavailable. This unavailability arises because the control mappings of each companion electronic device are typically distinct to the respective device. For instance, if the second companion electronic device, configured as a left earbud, includes control mappings for actions such as answering calls, adjusting volume, or toggling noise cancellation, these functionalities cannot be accessed when the left earbud is not in use.

Users operating in a mono mode such as that shown in FIG. 4, where only one earbud is active, would therefore face limitations in performing actions that are mapped to the inactive earbud. This scenario can lead to a diminished user experience, as users may need to manually interact with their primary device, such as a smartphone, to perform the desired actions. The lack of access to the control mappings of the inactive earbud disrupts the seamless and intuitive control that users expect from their TWS earbuds, particularly in situations where quick and convenient access to these controls is crucial.

Embodiments of the disclosure contemplate that the user 303 may prefer using a single companion electronic device of the asymmetrically control mapped electronic device pair as shown in FIG. 4 for a variety of reasons. Illustrating by example, the user 303 may prefer to use a single earbud to listen to music while remaining aware of their surroundings, a mode referred to as “mono mode” where a combined left/right channel is transmitted 405 from the electronic device 300 to the first companion electronic device 301.

In other instances, the user 303 may be compelled into the mono mode when one earbud's battery depletes or malfunctions. When prior art TWS earbuds assign specific functions to each earbud, such as volume control or toggling active noise cancellation (ANC), When operating in the mono mode users lose access to the functionalities assigned to the inactive earbud. For example, if a user wears only the left earbud, they may be unable to perform actions like turning the volume down or answering calls if those gestures are configured on the right earbud.

This limitation can lead to significant inconvenience. For instance, if a user receives a phone call while using only one earbud, the user may be unable to answer the call if the gesture to do so is assigned to the inactive earbud. This scenario necessitates manual intervention, such as pulling out the phone to answer the call, which disrupts the user experience. The need to manually configure functions each time based on which earbud is in use further complicates the user experience, making the user experience less intuitive and seamless.

To illustrate by example, consider a scenario where a user, Lisa, frequently uses her TWS earbuds during her daily jogs. Lisa enjoys listening to music and staying connected through hands-free calls. One day, while jogging, the battery in one of her earbuds becomes depleted of energy, forcing her to switch to mono mode. As she continues her run, she receives a call from her friend, Mark. Lisa attempts to answer the call by tapping her earbud but quickly realizes that the gesture to answer calls is configured on the other earbud, which is now inactive due to the battery depletion. Lisa has to stop her run, take out her phone, and manually answer the call.

In another instance, imagine a user named John who is using his TWS earbuds while working from home. John often switches between listening to music and attending virtual meetings. One day, he decides to use only one earbud to stay aware of his surroundings. During a meeting, John needs to adjust the volume, but the gesture for volume control is mapped to the other earbud, which he is not wearing. John finds himself unable to adjust the volume without manually changing the settings on his device, disrupting his workflow and causing inconvenience.

These real-life use cases highlight the challenges users face when operating prior art TWS earbuds in mono mode. The inability to access certain controls mapped to the inactive earbud can lead to a diminished user experience. For these reasons, embodiments of the disclosure contemplate there is a strong desire to enhance the overall user experience in mono mode by ensuring that functionalities remain accessible regardless of which earbud is in use.

Advantageously, embodiments of the disclosure address these challenges by dynamically remapping control gestures to the active earbud, ensuring that users retain full control functionality regardless of which earbud is in use. This approach enhances the overall usability and convenience of TWS earbuds, providing a seamless and uninterrupted user experience even in mono mode operation. This improvement aims to provide a more convenient and user-friendly experience, eliminating the need for manual configuration and ensuring that users can perform necessary actions even when operating with a single earbud.

To again illustrate by example, in FIG. 4 the user 303 is listening to Mac's Chicken Shack Boogie Woogie (shown on the user interface (318) of the electronic device 300 in FIG. 3) in a mono mode to stay aware of his surroundings. In the mono mode, a single left/right channel 406 is transmitted 405 from the electronic device 300 to the first companion electronic device 301. This configuration allows the user 303 to fully enjoy the music, appreciating the magical use of both the natural third and flat third by Buster, which imparts a bluesy sound.

Buster and his Bluesmen are renowned for their unique blend of traditional blues and modern influences. Buster, the lead guitarist and vocalist, is known for his exceptional guitar skills and soulful voice. His ability to seamlessly integrate the natural third and flat third in his compositions creates a distinctive bluesy character that resonates with listeners. The Bluesmen, comprising a talented group of musicians, provide a rich and dynamic backdrop to Buster's performances, enhancing the overall musical experience.

The user 303 loves Buster's Bluesmen for several reasons. The intricate guitar riffs and soulful melodies resonate deeply with the user 303, creating an immersive listening experience. The tune Mac's Chicken Shack Boogie Woogie, in particular, stands out due to the energetic rhythm and the blend of musical elements that Buster incorporates. The user 303 finds the combination of the natural third and flat third especially captivating, as the combination adds a distinctive bluesy character to the music, making the tune a favorite during daily activities. Additionally, the heartfelt lyrics and emotive delivery by Buster evoke a sense of nostalgia and connection, further endearing the music to the user 303.

In this illustrative example, while listening to Mac's Chicken Shack Boogie Woogie the user 303 receives an incoming call 407 from a friend, KB. The user 303, deeply immersed in the intricate guitar riffs and soulful melodies of Buster and his Bluesmen, appreciates the blend of traditional blues and modern influences. The energetic rhythm and the blend of musical elements, particularly the use of both the natural third and flat third by Buster, create a captivating and immersive listening experience. Despite the enjoyment derived from the music, the user 303 recognizes the importance of the incoming call from KB.

KB, a close friend of the user 303, often provides insights and support in various aspects of life. The user 303 understands that calls from KB typically involve significant and timely information, making the interruption of the music to accept the call. The user 303, aware of the potential urgency or importance of KB's call, decides to prioritize the communication over the ongoing musical experience. This decision underscores the user's motivation to maintain strong personal connections and stay informed about matters, even at the expense of pausing a favorite tune.

As described above with reference to FIG. 2, the control mapping (306) assigned to the second companion electronic device 302 is the control mapping (306) used to answer calls. The second companion electronic device 302, configured as a left earbud, includes control mappings for actions such as answering calls, adjusting volume, and toggling noise cancellation. These functionalities are mapped to the user interface of the second companion electronic device 302, allowing users to perform these actions through predefined gestures.

When the second companion electronic device 302 is not in use, the control mappings associated with the second companion electronic device 302 would, with prior art systems, become unavailable. This unavailability arises because the control mappings of each companion electronic device are typically distinct to the respective device. For instance, if the second companion electronic device 302 is not being worn or is inactive due to battery depletion, the user loses access to the functionalities mapped to the control mapping 306 of the second companion electronic device 302. This scenario can lead to significant inconvenience, as users may need to manually interact with their primary device, such as a smartphone, to perform the desired actions.

In the context of answering calls, if the user is only wearing the first companion electronic device 301, which does not have the control mapping (306) for answering calls, the user would be unable to answer an incoming call through the earbud. This limitation disrupts the seamless and intuitive control that users expect from their TWS earbuds, particularly in situations where quick and convenient access to these controls is significant.

Advantageously, embodiments of the disclosure address this challenge by providing a method 400 that dynamically remaps control gestures to the active earbud, thereby ensuring that users retain full control functionality regardless of which earbud is in use. To wit, in one or more embodiments the method 400 involves determining, at step 401 with a communication device paired with an asymmetrically control mapped companion electronic device pair, that only one control mapped companion electronic device (here first companion electronic device 301) is actively being used by the user 303.

In one or more embodiments, at step 402 the communication device (317) of electronic device 300 receives signals from the only one control mapped companion electronic device indicating that a control mapping switch gesture 408 was received by a user interface of the only one control mapped companion electronic device. In one or more embodiments, the communication device (317) then delivers remapping control signals 409 to the only one control mapped companion electronic device. At step 403, this causes a control map at the user interface to switch from a first control mapping (311) to a second control mapping (306).

In one or more embodiments, the first control mapping (311) is a default control mapping for the only one control mapped companion electronic device of the asymmetrically control mapped companion electronic device pair, and the second control mapping (306) is another default control mapping of another control mapped companion electronic device of the asymmetrically control mapped companion electronic device pair. In one or more embodiments, the first control mapping (311) and the second control mapping (306) are different, ensuring that the user 303 retains access to all necessary controls regardless of which earbud is in use. This method 400 enhances the usability and convenience of the electronic device, particularly in scenarios where the user may have limited ability to interact with both earbuds simultaneously.

At step 403 of FIG. 4, in response to receipt of the remapping control signals 409, the control mapping (311) of the first companion electronic device 301 is remapped with the control mapping (306) of the second companion electronic device 302. In one or more embodiments, this remapping process occurring at step 403 involves the one or more processors of the first companion electronic device 301 executing instructions to transfer the control functionalities from the inactive second companion electronic device 302 to the active first companion electronic device 301. The remapping ensures that the user 303 retains access to all necessary controls, even when only one earbud is in use.

Once the remapping control signals 409 are received, the user interface of the first companion electronic device 301 is updated to reflect the new control mapping (306). This update allows the user 303 to perform actions that were previously available to the second companion electronic device 302. For example, if the control mapping (306) of the second companion electronic device 302 includes the gesture for answering calls, this functionality is now available on the first companion electronic device 301. The user 303 can then deliver subsequent user input to the user interface of the first companion electronic device 301, such as a tap or swipe gesture, to execute the corresponding control operation at step 404.

At step 404, in one or more embodiments the user 303 delivers the user input to the user interface of the first companion electronic device 301. The one or more processors of the first companion electronic device 301 detect this input and execute the corresponding control operation based on the remapped control mapping (306). In this scenario, the user 303 can answer the much-anticipated incoming call 407 from KB by performing the gesture that was originally mapped to the second companion electronic device 302. This dynamic remapping of control gestures ensures that the user 303 can maintain seamless and uninterrupted control over the TWS earbuds, enhancing the overall user experience even in mono mode operation.

The control mapping switch gesture 408 of the illustrative embodiment of FIG. 4 is shown explanatorily as a sliding gesture across the user interface of the first companion electronic device 301. This sliding gesture allows the user 303 to remap the control functionalities from the inactive second companion electronic device 302 to the active first companion electronic device 301. In one or more embodiments, the sliding gesture involves a user 303 swiping their finger across the touch-sensitive surface of the first companion electronic device 301, triggering the remapping process that occurs at step 403. Embodiments contemplate that this sliding gesture is intuitive and easy to perform, providing a seamless way for users to switch control mappings when operating in mono mode.

In addition to the illustrative sliding gesture, several other options for control mapping switch gestures could be used. One alternative is a long tap gesture, where the user presses and holds their finger on the touch-sensitive surface of the first companion electronic device 301 for a predefined duration. This long tap gesture can serve as a signal to initiate the control mapping switch, providing a straightforward and easily recognizable input method. Another option is a double tap gesture, where the user quickly taps the touch-sensitive surface twice in succession. This double tap gesture can be configured to trigger the remapping process, offering a quick and efficient way to switch control mappings.

Furthermore, a triple tap gesture can be employed as another control mapping switch gesture. In this case, the user taps the touch-sensitive surface three times in rapid succession, signaling the need to remap the control functionalities. This triple tap gesture provides an additional layer of differentiation from other gestures, reducing the likelihood of accidental activation. Additionally, a circular motion gesture can be considered, where the user traces a circular pattern on the touch-sensitive surface. This circular motion gesture can be recognized by the device's sensors and used to initiate the control mapping switch, offering a visually distinct input method.

These alternative control mapping switch gestures, including the long tap, double tap, triple tap, and circular motion gestures, provide users with various options to suit their preferences and usage scenarios. By incorporating multiple gesture options, the system can accommodate different user behaviors and ensure that the control mapping switch process remains intuitive and accessible. Each gesture can be configured to trigger the remapping process, allowing users to retain full control functionality regardless of which earbud is in use, thereby enhancing the overall user experience in mono mode operation.

In the illustrative embodiment of FIG. 4, electronic device 300 causes the remapping occurring at step 403 by transmitting the remapping control signals 409 to the first companion electronic device 301. This transmission occurs in response to the communication device (317) of electronic device 300 receiving signals from first companion electronic device 301 indicating that a control mapping switch gesture 408 was received by a user interface of the first companion electronic device 301. The electronic device 300, upon detecting the control mapping switch gesture, initiates the remapping process by sending the appropriate control signals to the first companion electronic device 301, thereby enabling the remapping of the control functionalities from the inactive second companion electronic device 302 to the active first companion electronic device 301.

In one or more embodiments, the electronic device 300 comprises a communication device (317) and one or more processors (316) operable with the communication device (317). In one or more embodiments, in response to determining that only one companion electronic device of an asymmetrically control mapped companion electronic device pair is actively being used and is receiving a control mapping switch gesture 408 at a user interface, the one or more processors (316) of the electronic device 300 cause the only one companion electronic device to remap the user interface at step 403 with a control mapping belonging to another companion electronic device of the asymmetrically control mapped companion electronic device pair. This remapping ensures that the user retains access to all necessary controls, thereby maintaining a seamless and uninterrupted user experience even in mono mode operation.

In one or more embodiments, the one or more processors (316) determine that the only one companion electronic device of the asymmetrically control mapped companion electronic device pair is actively being used when the communication device (317) receives proximity sensor signals indicating an in-ear condition only from the earbud. The proximity sensors can detect objects proximately located with the user interface actuator or device housing of the electronic device. The proximity sensors can be active proximity sensors that include a transmitter and receiver pair, or passive proximity sensors that include a receiver only. The proximity sensors can be used for gesture control and other user interface protocols, as well as for distance determination.

In one or more embodiments, the one or more processors (316) determine that the only one companion electronic device of the asymmetrically control mapped companion electronic device pair is actively being used when the communication device (317) receives motion data signals only from the earbud. The motion sensors can function as an orientation detector configured to determine the spatial orientation of the companion electronic devices in three-dimensional space. The motion sensors can include one or more accelerometers or gyroscopes, which can detect motion, sense gestures, and determine the spatial orientation of the companion electronic devices relative to the earth's magnetic field.

The one or more processors (316) can also be operable to determine that the only one companion electronic device of the asymmetrically control mapped companion electronic device pair is actively being used when the earbud is operating in a monoaural mode of operation. In this mode, the communication device (317) is in communication only with the single active earbud. If, for example, the first companion electronic device 301 is the only earbud in use, remapping the default control mapping to another control mapping in response to a switch gesture ensures that control functionalities are not lost when one earbud is inactive or not worn. This dynamic remapping of control gestures to the active earbud provides a consistent and uninterrupted user experience, improving the overall functionality and convenience of the TWS earbuds.

In one or more embodiments, the one or more processors (316) determine that the only one companion electronic device of the asymmetrically control mapped companion electronic device pair is actively being used when the communication device (317) is in communication only with the only one companion electronic device. This determination can be performed using various techniques, each leveraging different sensors and data analysis methods to ensure accurate identification of the companion electronic device pair. By employing a combination of these techniques, the system can achieve robust and reliable detection of the active companion electronic device, ensuring seamless functionality and user experience.

In effect, electronic device 300 is responsible for causing the remapping occurring at step 403 in the system depicted in FIG. 4. The one or more processors of electronic device 300 detect the control mapping switch gesture and subsequently transmit the remapping control signals 409 to the first companion electronic device 301. This ensures that the user retains access to all necessary controls, even when only one earbud is in use. The dynamic remapping of control gestures to the active earbud provides a consistent and uninterrupted user experience, enhancing the overall functionality and convenience of the TWS earbuds.

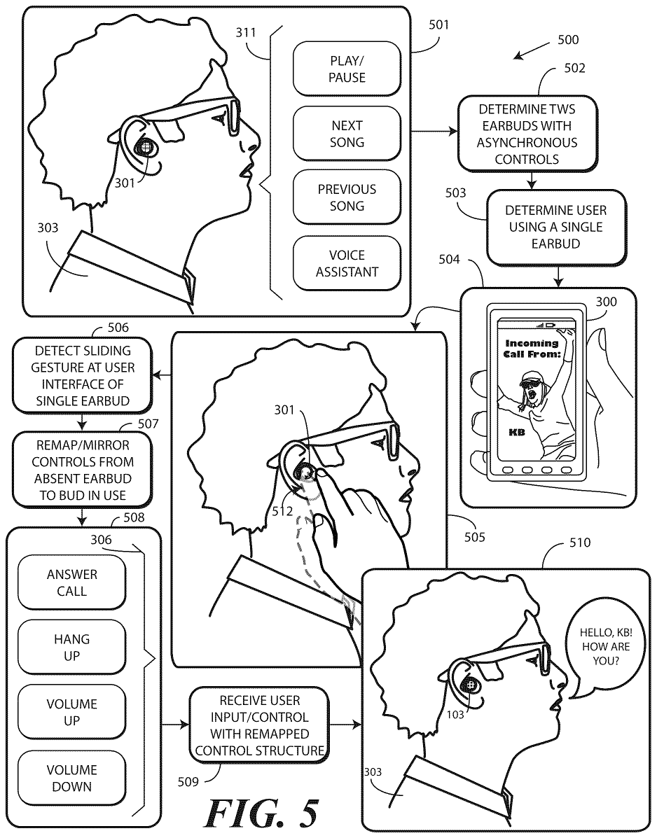

In other embodiments, however, the one or more processors of the first companion electronic device 301 can perform the remapping of step 403 independently of electronic device 300. Turning now to FIG. 5, illustrated therein is one such method 500 showing how this can occur.

In this method 500, the first companion electronic device 301, upon detecting the control mapping switch gesture of step 505 at the user interface at step 506, autonomously initiates the remapping process at step 507. The one or more processors (202) of the first companion electronic device 301 execute instructions to transfer the control functionalities from the inactive second companion electronic device (302) to the active first companion electronic device 301 without requiring intervention from electronic device 300. This independent remapping capability further enhances the flexibility and usability of the TWS earbuds, ensuring that users can maintain seamless control over their devices in various usage scenarios.

At step 501 of FIG. 5, the user 303 is again using the first companion electronic device 301 in a mono mode of operation. The first companion electronic device 301 has associated therewith a default control mapping 311. This default control mapping 311 allows the user 303 to play or pause music, advance to the next song, back up to the previous song, and enable a voice assistant.

As with the illustrative example of FIG. 4, at step 501 the user 303 is again listening to Mac's Chicken Shack Boogie Woogie, a favorite tune that features a blend of traditional blues and modern influences. As the user 303 listens to Mac's Chicken Shack Boogie Woogie, the user 303 may be singing along to some of the lyrics. The lyrics of the song include lines such as, “Down at Mac's Chicken Shack, where the boogie's at,” and “Buster's guitar sings the blues, with a rhythm you can't refuse.” These lyrics capture the essence of the song, with the song's energetic rhythm and soulful melodies, creating an immersive listening experience for the user 303.

At step 502, one or more processors (202) of the first companion electronic device 301 determine that the first companion electronic device 301 is a companion electronic device of an asymmetrically control mapped companion electronic device pair. This determination can be performed using various techniques, each leveraging different sensors and data analysis methods to ensure accurate identification of the companion electronic device pair.

One technique involves utilizing proximity sensors embedded within the first companion electronic device 301. These sensors detect the presence and proximity of the second companion electronic device 302. By analyzing the proximity data, the processors (202) can ascertain whether the first companion electronic device 301 is part of an asymmetrically control mapped companion electronic device pair. This method ensures real-time detection and can dynamically adjust to changes in the relative positions of the devices. Other techniques will be obvious to those of ordinary skill in the art having the benefit of this disclosure.

At step 503 of FIG. 5, one or more processors (202) of the first companion electronic device 301 determine that the first companion electronic device 301 is the only companion electronic device of the asymmetrically control mapped companion electronic device pair that is actively in use. This determination can be performed using various techniques, each leveraging different sensors and data analysis methods to ensure accurate identification of the companion electronic device pair.

One technique involves utilizing proximity sensors embedded within the first companion electronic device 301. These sensors detect the presence and proximity of the second companion electronic device (302). By analyzing the proximity data, the processors (202) can ascertain whether the first companion electronic device 301 is part of an asymmetrically control mapped companion electronic device pair. This method ensures real-time detection and can dynamically adjust to changes in the relative positions of the devices.

Another technique employs motion sensors, such as accelerometers and gyroscopes, to detect the movement and orientation of the first companion electronic device 301. By comparing the motion data from both companion electronic devices, the processors (202) can determine if only one device is actively in use. This approach is particularly effective in scenarios where the user is moving, as the system can distinguish between the active and inactive devices based on their motion patterns.

Additionally, the processors (202) can use in-ear detection sensors to identify whether the first companion electronic device 301 is being worn by the user. These sensors can detect the presence of the device in the user's ear canal, providing a reliable indication of active use. This technique is beneficial in ensuring that the device is not only powered on but also actively being used by the user.

Another method involves monitoring the battery levels of both companion electronic devices. If the battery level of the second companion electronic device (302) falls below a predefined threshold, the processors (202) can infer that the device is not actively in use. This approach is useful in scenarios where one device may be inactive due to battery depletion.

Each of these techniques offers distinct advantages. Proximity sensors provide real-time detection and can dynamically adjust to changes in device positions. Motion sensors offer accurate differentiation based on movement patterns, making them effective in active scenarios. In-ear detection sensors ensure that the device is being worn and actively used by the user. Monitoring battery levels provides a straightforward method to infer inactivity due to power constraints. By employing a combination of these techniques, the system can achieve robust and reliable detection of the active companion electronic device, ensuring seamless functionality and user experience.

At step 504 of FIG. 5, an electronic device 300 actively in communication with the first companion electronic device 301 is again receiving an incoming call from KB. The user 303, who just spoke to KB five minutes ago, may find this call to be important due to KB's tendency to call frequently, especially whenever something new comes to mind. This pattern of frequent communication suggests that KB often has timely and relevant information to share, which the user 303 may consider significant.

Given the recent conversation, the user 303 might anticipate that KB's call could be a follow-up on the previous discussion or an update. The user's awareness of KB's communication habits, including the propensity to call whenever there is new information, further underscores the potential importance of the incoming call. This context highlights the need for the user 303 to have seamless access to call management functionalities, even when operating in mono mode with only the first companion electronic device 301 actively in use.

At step 505, the user 303 is aware that the answer call controls are mapped to the second companion electronic device (302), which is currently not in use. This awareness stems from the user's familiarity with the control mappings of the asymmetrically control mapped companion electronic device pair and with the workings of embodiments of the disclosure. As such, the user 303 understands that the predefined gesture for answering calls is configured on the second companion electronic device 302, and without access to this device, the user 303 cannot answer the incoming call from KB using the default control mapping of the first companion electronic device 301.

Given the urgency and importance of speaking with KB, the user 303 decides to initiate a control remapping to ensure that the answer call functionality becomes accessible on the first companion electronic device 301. To achieve this, at step 505 the user 303 delivers a predefined gesture 512 to the user interface of the first companion electronic device 301, which in this illustrative embodiment is a sliding gesture. This predefined gesture, recognized by the system, triggers the remapping process, allowing the control functionalities of the second companion electronic device 302 to be transferred to the first companion electronic device 301. As a result, the user 303 can now answer the incoming call from KB using the first companion electronic device 301, ensuring seamless communication and maintaining the desired user experience.

Specifically, at step 506 one or more processors (202) of the first companion electronic device 301 detect the predefined gesture 512 occurring at the user interface. At step 507, the one or more processors (202) replace a default control mapping of the first companion electronic device 301, represented by control mapping 311, with another default control mapping of the second companion electronic device (302), represented by control mapping 306, which is shown at step 508.

In one or more embodiments, step 509 then comprises receiving, by the user interface of the first companion electronic device 301, user input after the replacing occurring at step 507. In one or more embodiments, step 509 also comprises controlling, by the one or more processors (202), the first companion electronic device 301 as a function of where the user input is received at the another default control mapping. This allows the user 303 to talk to KB using the first companion electronic device 301 at step 510.

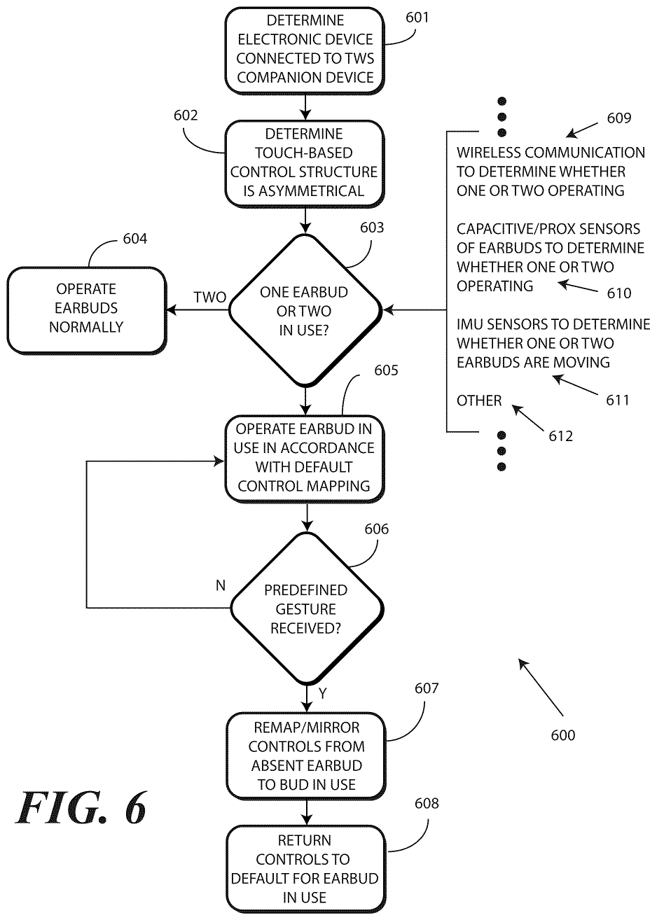

Turning now to FIG. 6, illustrated therein is another explanatory method 600 in accordance with one or more embodiments of the disclosure. At step 601 of FIG. 6, one or more processors of an electronic device determine that the electronic device is paired with one or more companion electronic devices of an asymmetrically control mapped companion electronic device pair. This determination can be performed using various techniques, each leveraging different sensors and data analysis methods to ensure accurate identification of the companion electronic device pair.

One technique involves utilizing proximity sensors embedded within the electronic device. These sensors detect the presence and proximity of the companion electronic devices. By analyzing the proximity data, the processors can ascertain whether the electronic device is part of an asymmetrically control mapped companion electronic device pair. This method ensures real-time detection and can dynamically adjust to changes in the relative positions of the devices.

Another technique employs motion sensors, such as accelerometers and gyroscopes, to detect the movement and orientation of the electronic device. By comparing the motion data from both companion electronic devices, the processors can determine if the devices are part of an asymmetrically control mapped companion electronic device pair. This approach is particularly effective in scenarios where the user is moving, as the system can distinguish between the active and inactive devices based on their motion patterns.

Additionally, the processors can use in-ear detection sensors to identify whether the electronic device is being worn by the user. These sensors can detect the presence of the device in the user's ear canal, providing a reliable indication of active use. This technique is beneficial in ensuring that the device is not only powered on but also actively being used by the user.

Another method involves monitoring the battery levels of the companion electronic devices. If the battery level of one of the companion electronic devices falls below a predefined threshold, the processors can infer that the device is not actively in use. This approach is useful in scenarios where one device may be inactive due to battery depletion. Each of these techniques offers distinct advantages.

Proximity sensors provide real-time detection and can dynamically adjust to changes in device positions. Motion sensors offer accurate differentiation based on movement patterns, making them effective in active scenarios. In-ear detection sensors ensure that the device is being worn and actively used by the user. Monitoring battery levels provides a straightforward method to infer inactivity due to power constraints. By employing a combination of these techniques, the system can achieve robust and reliable detection of the active companion electronic device, ensuring seamless functionality and user experience.

At step 602 of FIG. 6, the one or more processors of the electronic device determine that the control maps of the companion electronic devices are asymmetrical. Decision 603 then determines whether one companion electronic device of the asymmetrically control mapped companion electronic device pair actively being used or two. This determination can be performed using various techniques, each leveraging different sensors and data analysis methods to ensure accurate identification of the asymmetrical control mappings.

In one or more embodiments, decision 603 comprises determining that only one companion electronic device of the asymmetrically control mapped companion electronic device pair is actively being used when the communication device is in communication 609 only with only one companion electronic device. In other embodiments, decision 603 determines that only one companion electronic device of the asymmetrically control mapped companion electronic device pair is actively being used when the communication device receives proximity sensor signals 610 indicating an in ear condition only from one earbud.

In still other embodiments, decision 603 determines only one companion electronic device of the asymmetrically control mapped companion electronic device pair is actively being used when the communication device receives motion data signals 611 only from one earbud. Other techniques 612 can be sued as well, one example of which is determining only one companion electronic device of the asymmetrically control mapped companion electronic device pair is actively being used when one earbud is operating in a monoaural mode of operation as previously described. Still other techniques will be obvious to those of ordinary skill in the art having the benefit of this disclosure.

In one or more embodiments, when both companion electronic devices of the asymmetrically control mapped companion electronic device pair are in use, this means that both control mappings are available to control the asymmetrically control mapped companion electronic device pair. Accordingly, step 604 can operate the asymmetrically control mapped companion electronic device pair in a normal mode of operation.

In one or more embodiments, step 605 operates the companion electronic device that is actively in use with a default control mapping. Decision 606 then detects a predefined gesture at a user interface of the companion electronic device. This can be detected by one or more processors of the companion electronic device itself, or alternatively by another electronic device that receives signals indicating that a control mapping switch gesture was received by a user interface of the companion electronic device.

Where such a gesture is received, step 607 can comprise replacing the default control mapping of the companion electronic device with another default control mapping of the other companion electronic device of the asymmetrically control mapped companion electronic device pair. User input can be delivered to control the companion electronic device using this new mapping as well.

In one or more embodiments, the replacing of step 607 occurs when the another electronic device of the asymmetrically control mapped electronic device pair is not in use as determined by decision 603. In one or more embodiments, the replacing of step 607 occurs when an energy level of an energy storage device of the another electronic device of the asymmetrically control mapped electronic device pair is below a predefined threshold, thereby leaving only one electronic device in use as determined by decision 603.

Step 608 can then comprise returning the default control mapping to the companion electronic device in use. This step 608 can occur in response to a predefined condition occurring in one or more embodiments.

Illustrating by example, in one or more embodiments step 608 occurs when there is an expiration of a timer initiated when the predefined gesture is received. In other embodiments, step 608 comprises receiving the predefined gesture in the form of additional user input again at the user interface within a predefined duration threshold.

In still other embodiments, step 608 can occur when a predefined override gesture is received at the user interface. In one or more embodiments, the predefined override gesture comprises one of a long tap, a double tap, or a triple tap. Other override gestures will be obvious to those of ordinary skill in the art having the benefit of this disclosure.

In sum, the method 600 of FIG. 6 involves managing gesture controls of duo mode TWS operations in a mono mode. The system determines that an electronic device is connected with a short-range wearable device, such as TWS earbuds. The system identifies that among the supported operations via gestures on the TWS earbuds, at least one operation is controlled by a gesture on a specific earbud. The system employs TWS earbuds sensors, including in-ear detection, head movement, and IMU sensors, individually or in combination, to determine a mono mode usage of TWS where only one earbud is being used or active while the other earbud is not operational.

The system checks if one or two earbuds are connected to the device and uses cap proximity sensor data to determine if the earbuds are worn by the user. The system also uses IMU sensors data to determine the relative movement of the earbuds and checks if they are in sync to get the number of listeners. Upon detecting that TWS is being used in a mono mode, the system enables an override switch gesture. This switch gesture allows the user to switch controls of both earbuds. When this feature is enabled, the dedicated individual controls for the left or the right earbud are remapped to any single earbud by using the override switch.

For example, if the user is wearing only the left earbud, normally operations on the left earbud are supported. However, if the user slides on the left earbud, the left earbud would now invoke commands meant for the right earbud on a particular gesture, such as pressing and holding for two seconds to invoke Google Assistant. This remapping ensures that users retain full control functionality regardless of which earbud is in use, thereby enhancing the overall user experience in mono mode operation.

As noted, in the method 600 of FIG. 6, the replacing of step 607 occurs when the another electronic device of the asymmetrically control mapped electronic device pair is not in use as determined by decision 603. However, embodiments of the disclosure contemplate that a user may wish to perform a remapping process even when two companion electronic devices of an asymmetrically control mapped companion electronic device pair are in use.

Illustrating by example, users may want to remap the control mappings of one companion electronic device of an asymmetrically control mapped companion electronic device pair with the control mapping of the other companion electronic device even when both companion electronic devices are in use to enhance convenience and accessibility in various scenarios. For instance, consider a user carrying a baby in one arm. In this situation, the user may find interacting with the earbud on the same side as the arm holding the baby challenging. By remapping the control mappings, the user can perform necessary actions, such as answering calls or adjusting volume, using the earbud on the free side, thereby maintaining seamless control without disturbing the baby.

Another example involves a user carrying groceries or a package. When both hands are occupied, the user may struggle to access the controls on one of the earbuds. Remapping the control mappings allows the user to manage audio playback, handle calls, or activate voice assistants using the earbud that is more accessible, ensuring uninterrupted functionality. This flexibility is particularly beneficial in scenarios where quick and efficient access to controls is necessary, such as when receiving an important call or needing to adjust the volume in a noisy environment.

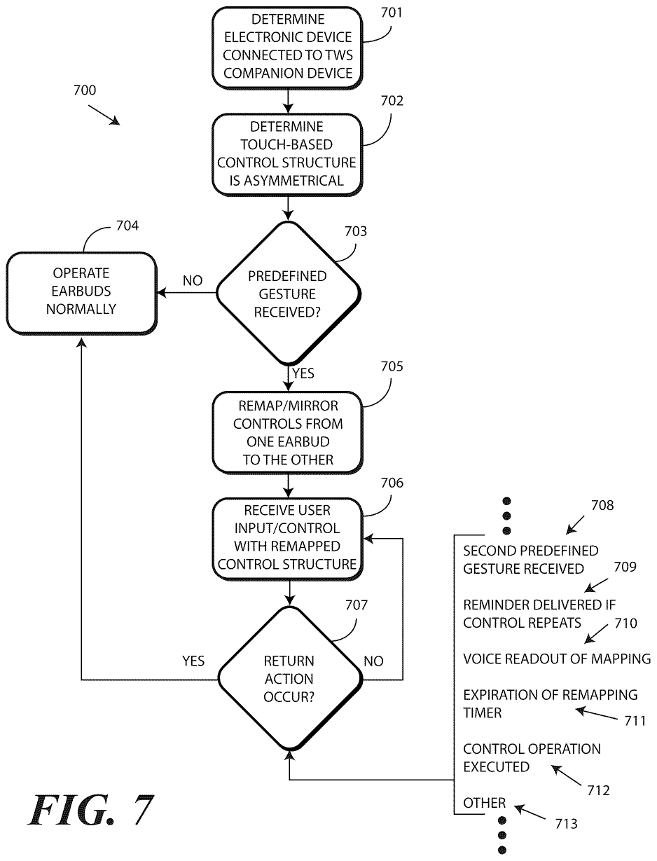

Additionally, users may encounter situations where one earbud is temporarily less accessible due to physical constraints or activities. For example, a user might be holding a cup of coffee in one hand while navigating through a crowded area. In such cases, remapping the control mappings enables the user to perform actions using the more accessible earbud, enhancing the overall user experience by providing intuitive and adaptable control mechanisms. This dynamic remapping ensures that users can maintain full control functionality regardless of their physical circumstances, thereby improving the usability and convenience of the asymmetrically control mapped companion electronic device pair. Turning now to FIG. 7, illustrated therein is one explanatory method 700 for satisfying such users.

Beginning at step 701 of FIG. 7, in one or more embodiments step 701 involves determining that an electronic device is actively communicating with two companion electronic devices of an asymmetrically control mapped companion electronic device pair. This determination ensures that the electronic device can manage and coordinate the control mappings of both companion electronic devices effectively.

In one or more embodiments, the process begins with the electronic device establishing a communication link with each of the companion electronic devices. This communication link can be facilitated through various wireless protocols, such as Bluetooth™, Wi-Fi, or other near-field communication technologies.

Once the communication link is established, the electronic device continuously monitors the status and activity of each companion electronic device in one or more embodiments. This monitoring involves receiving and analyzing signals from the companion electronic devices, which may include proximity sensor data, motion sensor data, and other relevant information. The electronic device uses this data to verify that both companion electronic devices are actively in use and are functioning as part of the asymmetrically control mapped companion electronic device pair.

In one or more embodiments, the electronic device employs proximity sensors to detect the presence and proximity of each companion electronic device. These sensors can determine whether the companion electronic devices are within a predefined range and are being worn by the user. Additionally, motion sensors, such as accelerometers and gyroscopes, can provide data on the movement and orientation of the companion electronic devices, further confirming their active use. By leveraging these sensors and data analysis techniques, the electronic device can accurately determine that the electronic device is actively communicating with both companion electronic devices, ensuring seamless coordination and control of the asymmetrically control mapped companion electronic device pair.

In one or more embodiments, step 702 involves determining that the control mappings of each companion electronic device of the asymmetrically control mapped companion electronic device pair are asymmetrical. This determination ensures that the control functionalities assigned to each device are distinct and not identical. The process begins with the electronic device analyzing the control mappings of both companion electronic devices to identify differences in their assigned functionalities. This analysis involves comparing the predefined gestures and corresponding actions associated with each device to ascertain whether they are asymmetrical.

In one or more embodiments, the electronic device employs various techniques to perform this analysis. One technique involves utilizing a database or memory storage that contains the control mappings for each companion electronic device. The electronic device retrieves the control mappings from this storage and performs a comparative analysis to identify any differences in the assigned functionalities. This method ensures that the control mappings are accurately compared and any asymmetries are detected.

Another technique involves real-time monitoring of user interactions with each companion electronic device. The electronic device tracks the gestures performed by the user and the corresponding actions executed by each device. By analyzing this data, the electronic device can determine whether the control mappings are asymmetrical based on the observed differences in functionalities. This approach provides a dynamic and real-time assessment of the control mappings, ensuring that any changes or updates to the mappings are promptly detected.

Additionally, the electronic device can utilize machine learning algorithms to enhance the accuracy of the asymmetry determination. These algorithms analyze historical data on user interactions and control mappings to identify patterns and predict potential asymmetries. By leveraging machine learning, the electronic device can continuously improve the ability to detect asymmetrical control mappings, ensuring a robust and reliable determination process.

Once the electronic device determines that the control mappings are asymmetrical, the electronic device can proceed with the necessary actions to manage the control functionalities effectively. This determination ensures that users can seamlessly switch control mappings between companion electronic devices, enhancing the overall user experience and maintaining intuitive and efficient control mechanisms.

Decision 703 involves determining whether a predefined gesture is received at a user interface of an electronic device. The one or more processors of the electronic device can continuously monitor the user interface for specific user inputs that match predefined gestures. These predefined gestures can include various types of user interactions, such as a sliding gesture, a long tap, a double tap, or a triple tap. The electronic device employs sensors and control circuits to detect these gestures accurately and in real-time. Where no predefined gesture is received, the asymmetrically control mapped companion electronic device pair operate normally at step 704.

Upon detecting a user interaction, the one or more processors analyze the input to ascertain whether the input corresponds to one of the predefined gestures at decision 703. This analysis can involve comparing the detected input against stored patterns or criteria that define each predefined gesture. For instance, a sliding gesture may be identified by a continuous movement across the touch-sensitive surface, while a long tap may be recognized by a prolonged touch at a specific location. The processors utilize algorithms and data from sensors, such as capacitive touch sensors or motion sensors, to perform this comparison and determine if the input matches a predefined gesture.

If the input matches a predefined gesture, the one or more processors proceed to execute the corresponding control operation associated with that gesture at step 705. This may involve remapping control functionalities, adjusting settings, or performing specific actions as defined by the control mapping of the electronic device. The detection and recognition of predefined gestures ensure that the electronic device can respond promptly and accurately to user inputs, enhancing the overall user experience by providing intuitive and efficient control mechanisms. User controls can then be received and executed using the remapping at decision 706.

In one or more embodiments, decision 707 of FIG. 7 involves determining whether a return action has occurred, causing the control mapping of a particular companion electronic device to return to the default mapping. This decision ensures that the control functionalities of the companion electronic device revert to their original state after a temporary remapping has been applied. The return action can be triggered by various predefined conditions, such as the expiration of a timer 711, the delivery of an audible reminder 709 when a user delivers user input that would repeatedly cause the same control operation to occur, in response to vocal readouts 710 of the current control mapping, the receipt of a specific user input executing a control operation 712, the detection of an override gesture 708, or for other reasons 713.

In one or more embodiments, the return action occurs when a timer 711, initiated at the time of the control mapping switch, expires. This timer-based approach ensures that the remapping is temporary and automatically reverts to the default control mapping after a specified duration. This method is particularly useful in scenarios where the remapping is intended for short-term use, such as during a specific activity or task.

Another predefined condition that can trigger the return action is the receipt of a specific user input at the user interface of the companion electronic device. For instance, if the user performs the same predefined gesture that initiated the control mapping switch within a predefined duration threshold, the system recognizes this input as a signal to revert to the default control mapping. This approach provides users with a straightforward and intuitive way to return to the original control functionalities without requiring additional steps or commands.

Additionally, the return action can be triggered by the detection of a predefined override gesture at the user interface. This override gesture can include various types of user inputs, such as a long tap, a double tap, or a triple tap. By recognizing these specific gestures, the system can promptly revert the control mapping to the default state, ensuring that users can easily switch back to the original control functionalities when needed. This method offers flexibility and convenience, allowing users to manage the control mappings of their companion electronic devices effectively.

Decision 707 of FIG. 7 plays a role in managing the control mappings of companion electronic devices by determining whether a return action has occurred. By leveraging predefined conditions such as timer expiration, specific user inputs, and override gestures, the system ensures that the control functionalities revert to their default state when appropriate, enhancing the overall user experience and maintaining intuitive and efficient control mechanisms.

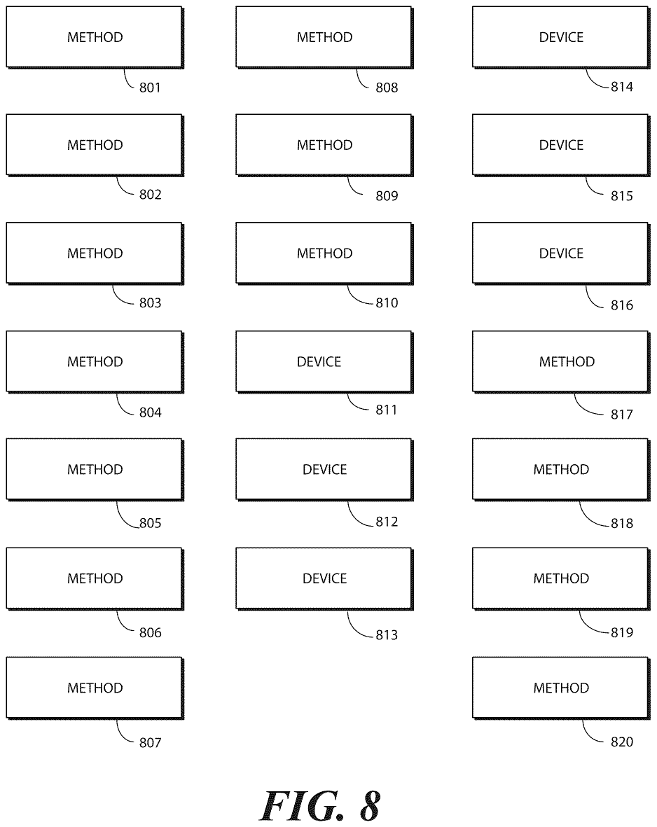

Turning now to FIG. 8, illustrated therein are various embodiments of the disclosure. The embodiments of FIG. 8 are shown as labeled boxes in FIG. 8 due to the fact that the individual components of these embodiments have been illustrated in detail in FIGS. 1-7, which precede FIG. 8. Accordingly, since these items have previously been illustrated and described, their repeated illustration is no longer essential for a proper understanding of these embodiments. Thus, the embodiments are shown as labeled boxes.

At 801, a method in an electronic device of an asymmetrically control mapped electronic device pair comprises detecting, by one or more processors of the electronic device, a predefined gesture at a user interface. At 801, the method comprises replacing, by the one or more processors at the user interface, a default control mapping of the electronic device with another default control mapping of another electronic device of the asymmetrically control mapped electronic device pair. At 802, the predefined gesture of 801 comprises a sliding gesture.

At 803, the method of 801 further comprises receiving, by the user interface, user input after the replacing. At 803, the method comprises controlling, by the one or more processors, the electronic device as a function of where the user input is received at the another default control mapping.

At 804, the method of 803 further comprises returning, by the one or more processors at the user interface, the default control mapping in response to a predefined condition occurring. At 805, the predefined criterion of 804 comprises an expiration of a timer initiated when the predefined gesture is received.

At 806, the predefined criterion of 804 comprises receiving the user input again at the user interface within a predefined duration threshold. At 807, the predefined criterion of 804 comprises receiving a predefined override gesture at the user interface. At 808, the predefined override gesture of 807 comprises one of a long tap, a double tap, or a triple tap.

At 809, the replacing of 801 occurs when the another electronic device of the asymmetrically control mapped electronic device pair is not in use. At 810, the replacing of 801 occurs when an energy level of an energy storage device of the another electronic device of the asymmetrically control mapped electronic device pair is below a predefined threshold.

At 811, an electronic device comprises a communication device and one or more processors operable with the communication device. At 811, the one or more processors, in response to determining that only one companion electronic device of an asymmetrically control mapped companion electronic device pair is actively being used and is receiving a control mapping switch gesture at a user interface, cause the only one companion electronic device to remap its user interface with a control mapping belonging to another companion electronic device of the asymmetrically control mapped companion electronic device pair.

At 812, the only one companion electronic device of 811 comprises an earbud. At 813, the one or more processors of 812 determine that the only one companion electronic device of the asymmetrically control mapped companion electronic device pair is actively being used when the communication device receives proximity sensor signals indicating an in ear condition only from the earbud.

At 814, the one or more processors of 812 determine that the only one companion electronic device of the asymmetrically control mapped companion electronic device pair is actively being used when the communication device receives motion data signals only from the earbud. At 815, the one or more processors of 812 determine that the only one companion electronic device of the asymmetrically control mapped companion electronic device pair is actively being used when the earbud is operating in a monoaural mode of operation. At 816, the one or more processors of 812 determine that the only one companion electronic device of the asymmetrically control mapped companion electronic device pair is actively being used when the communication device is in communication only with the only one companion electronic device.

At 817, a method in an electronic device comprises determining, with a communication device paired with asymmetrically control mapped companion electronic device pair, that only one control mapped companion electronic device is actively being used by a user. At 817, the method comprises receiving, by the communication device from the only one control mapped companion electronic device, signals indicating that a control mapping switch gesture was received by a user interface of the only one control mapped companion electronic device. At 817, the method comprises delivering, by the communication device, remapping control signals to the only one control mapped companion electronic device causing a control map at the user interface to switch from a first control mapping to a second control mapping.

At 818, the first control mapping of 817 is a default control mapping for the only one control mapped companion electronic device of the asymmetrically control mapped companion electronic device pair, and the second control mapping is another default control mapping of another control mapped companion electronic device of the asymmetrically control mapped companion electronic device pair.

At 819, the first control mapping and the second control mapping of 818 are different. At 820, the only one control mapped companion electronic device pair of 819 is an earbud.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

For example, in one embodiment the electronic device comprises a communication device and one or more processors operable with the communication device, where the electronic device is configured as a truly wireless stereo (TWS) earbud. The communication device facilitates seamless interaction between the processors and the companion electronic devices, ensuring efficient communication and control.

In one or more embodiments, the processors are responsible for detecting when only one companion electronic device of an asymmetrically control mapped companion electronic device pair is actively being used and for recognizing a control mapping switch gesture at the user interface. Upon detection, the processors initiate a remapping process, transferring the control functionalities from the inactive companion electronic device to the active one.

In another embodiment, the electronic device includes proximity sensors to detect whether the earbud is being worn by the user, and motion sensors to determine the spatial orientation and movement of the earbud. These sensors provide data that the processors use to ascertain the active use of the earbud and to execute the control mapping switch.

Additionally, the electronic device may feature a touch-sensitive surface that allows users to perform various gestures, such as sliding, tapping, or holding, to control the functionalities of the earbud. In yet another embodiment, the electronic device can dynamically adjust the control mappings based on the battery levels of the companion electronic devices, ensuring that the user retains access to controls even when one earbud's battery is depleted. This adaptability enhances the overall user experience by providing intuitive and efficient control mechanisms, regardless of the user's physical circumstances or the operational status of the companion electronic devices.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device of an asymmetrically control mapped electronic device pair, the method comprising:
detecting, by one or more processors of the electronic device, a predefined gesture at a user interface; and
replacing, by the one or more processors at the user interface, a default control mapping of the electronic device with another default control mapping of another electronic device of the asymmetrically control mapped electronic device pair.

2. The method of claim 1, wherein the predefined gesture comprises a sliding gesture.

3. The method of claim 1, further comprising:
receiving, by the user interface, user input after the replacing; and
controlling, by the one or more processors, the electronic device as a function of where the user input is received at the another default control mapping.

4. The method of claim 3, further comprising returning, by the one or more processors at the user interface, the default control mapping in response to a predefined condition occurring.

5. The method of claim 4, wherein the predefined condition comprises an expiration of a timer initiated when the predefined gesture is received.

6. The method of claim 4, wherein the predefined condition comprises receiving the user input again at the user interface within a predefined duration threshold.

7. The method of claim 4, wherein the predefined condition comprises receiving a predefined override gesture at the user interface.

8. The method of claim 7, wherein the predefined override gesture comprises one of a long tap, a double tap, or a triple tap.

9. The method of claim 1, wherein the replacing occurs when the another electronic device of the asymmetrically control mapped electronic device pair is not in use.

10. The method of claim 1, wherein the replacing occurs when an energy level of an energy storage device of the another electronic device of the asymmetrically control mapped electronic device pair is below a predefined threshold.

11. An electronic device, comprising:
a communication device; and
one or more processors operable with the communication device;
wherein the one or more processors, in response to determining that only one companion electronic device of an asymmetrically control mapped companion electronic device pair is actively being used and is receiving a control mapping switch gesture at a user interface, cause the only one companion electronic device to remap its user interface with a control mapping belonging to another companion electronic device of the asymmetrically control mapped companion electronic device pair.

12. The electronic device of claim 11, wherein the only one companion electronic device comprises an earbud.

13. The electronic device of claim 12, wherein the one or more processors determine that the only one companion electronic device of the asymmetrically control mapped companion electronic device pair is actively being used when the communication device receives proximity sensor signals indicating an in ear condition only from the earbud.

14. The electronic device of claim 12, wherein the one or more processors determine that the only one companion electronic device of the asymmetrically control mapped companion electronic device pair is actively being used when the communication device receives motion data signals only from the earbud.

15. The electronic device of claim 12, wherein the one or more processors determine that the only one companion electronic device of the asymmetrically control mapped companion electronic device pair is actively being used when the earbud is operating in a monoaural mode of operation.

16. The electronic device of claim 12, wherein the one or more processors determine that the only one companion electronic device of the asymmetrically control mapped companion electronic device pair is actively being used when the communication device is in communication only with the only one companion electronic device.

17. A method in an electronic device, the method comprising:
determining, with a communication device paired with asymmetrically control mapped companion electronic device pair, that only one control mapped companion electronic device is actively being used by a user;
receiving, by the communication device from the only one control mapped companion electronic device, signals indicating that a control mapping switch gesture was received by a user interface of the only one control mapped companion electronic device; and
delivering, by the communication device, remapping control signals to the only one control mapped companion electronic device causing a control map at the user interface to switch from a first control mapping to a second control mapping.

18. The method of claim 17, wherein the first control mapping is a default control mapping for the only one control mapped companion electronic device of the asymmetrically control mapped companion electronic device pair. and the second control mapping is another default control mapping of another control mapped companion electronic device of the asymmetrically control mapped companion electronic device pair.

19. The method of claim 18, wherein the first control mapping and the second control mapping are different.

20. The method of claim 19, wherein the only one control mapped companion electronic device pair is an earbud.
